(19) United States
(12) Patent Application Publication
(10) Pub. No.: US 2005/0106489 A1
(43) Pub. Date: May 19, 2005

(54) Image forming apparatus and image forming method

(75) Inventors: Nobuyoshi Sugahara, Shizuoka (JP); Takayuki Itakura, Shizuoka (JP); Koh Ishigami, Shizuoka (JP); Hiroyuki Fujikawa, Kanagawa (JP); Takakuni Kobori, Ibaragi (JP); Hirohide Tanikawa, Shizuoka (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/988,773

(22) Filed: Nov. 16, 2004

(30) Foreign Application Priority Data
Nov. 18, 2003 (JP) 2003-387544

(51) Int. Cl. G03G 15/08

(52) U.S. Cl. 430/120; 399/159; 430/69

(57) ABSTRACT

An image forming apparatus includes an electrophotographic photosensitive member and a toner. The photosensitive member has a universal hardness of 1.5×10⁸ to 2.3×10⁸ N/m², the hardness being measured in an environment of 25° C. with a humidity of 50% using a Vickers diamond indenter having a quadrangular pyramid shape with a maximum load of 6 mN, and has an elastic deformation ratio of 46% to 65%. The toner has a weight average particle diameter of 4.0 to 8.0 μm, the average circularity of the toner having an equivalent circle diameter of at least 2 μm is 0.915 to 0.950, the toner has a storage modulus at 80° C. of 1×10⁵ to 1×10⁸ Pa, and a ratio of a loss modulus G″ of the toner to the storage modulus G′ of the toner (G″/G′=tan δ) is equal to 1 at a temperature in the range of 60° C. to 72° C.

This application claims priority from Japanese Patent Application No. 2003-387544 filed Nov. 18, 2003, which is hereby incorporated by reference herein.

### BACKGROUND OF THE INVENTION

1. Field of the Invention

The present invention relates to an electrophotographic apparatus including an electrophotographic photosensitive member and an image forming method.

2. Description of the Related Art

In image forming apparatuses such as copy machines, printers, and facsimiles to record images on a recording medium such as paper, an electrophotographic system is generally used as a system to record images on the recording medium.

In the electrophotographic system, a photosensitive drum having a photosensitive material disposed thereon is used as an image carrier. The surface of the photosensitive drum is uniformly charged, and is then irradiated with a laser beam. An electric potential difference is provided between irradiated parts and non-irradiated parts.

Subsequently, charged toner in a developer is fixed to the surface of the photosensitive drum to form a toner image. The toner image is then transferred to the recording medium. Thus, the image is formed on the recording medium.

Recently, demands to improve the image quality and to decrease the operation cost of the output equipment have been increasing. Therefore, in the photosensitive drum, which is the image carrier used in the electrophotographic system, a photosensitive layer having a smaller thickness is used to achieve high resolution. In addition, in order to decrease the operation cost, the lifetime of the photosensitive drum itself must be increased. For this purpose, trials to improve the electrical and mechanical strengths and wear resistance of the surface of the photosensitive member have been performed.

For example, Japanese Patent Laid-Open Nos. 02-127652, 05-216249, and 07-72640 disclose a surface layer composed of a curing resin to improve the durability of a photosensitive member. In the surface layer composed of the curing resin, scraping and flaws of the surface layer can be suppressed because the curing resin has a mechanical strength higher than that of a thermoplastic resin. As a result, the lifetime of the photosensitive member is increased.

After toner images are transferred to the recording medium, some toner remains on the surface of the photosensitive drum without being transferred to the recording medium. Since the surface of the photosensitive drum is repeatedly used to form toner images, the photosensitive drum requires a cleaning system to sufficiently remove the above residual toner. Various methods for removing the residual toner have been proposed. In a practical method, a counter blade (i.e., cleaning blade) composed of an elastic material is brought into contact with the surface of the photosensitive drum to scrape off the residual toner.

In order to improve the image quality in the electrophotographic system, various approaches in the development of toners have been actively investigated. For example, in order to improve the reproducibility of latent images and transfer performance, minute dots are formed by reducing the diameter of the toner or by spheroidizing the toner. In order to improve the low-temperature fixing property and image glossiness, the material used for and the composition of binder resins and release agents in the toner have been studied.

However, these approaches readily cause a toner to become fixed by melting on the surface of the photoreceptor drum. In other words, these approaches readily cause a filming phenomenon. Since a photoreceptor having a surface layer composed of a curing resin is difficult to scrape, in particular, such a photosensitive member readily causes such a filming phenomenon.

### SUMMARY OF THE INVENTION

It is an object of the present invention to provide an image forming apparatus and an image forming method wherein the image has superior durability, the generation of filming is suppressed after long-term use, and superior dot reproducibility and transfer performance can be achieved.

It is an object of the present invention to provide an image forming apparatus in which an electrostatic latent image formed on an electrophotographic photosensitive member is developed with a toner. The image forming apparatus of the present invention includes an electrophotographic photosensitive member comprising at least a conductive support, a photosensitive layer disposed on the support, and a surface layer composed of a curing resin, wherein the electrophotographic photosensitive member has a universal hardness (HU) of 1.5×10⁸ to 2.3×10⁸ N/m², the universal hardness being measured in an environment of 25° C. with a humidity of 50% using a Vickers diamond indenter having a quadrangular pyramid shape with a maximum indentation load of 6 mN, and the electrophotographic photosensitive member has an elastic deformation ratio of 46% to 65%. The image forming apparatus of the present invention also includes a toner comprising at least a binder resin, a colorant, and a release agent, wherein (i) the toner has a weight average particle diameter (D4) of 4.0 to 8.0 μm, (ii) the average circularity of the toner having an equivalent circle diameter of at least 2 μm is 0.915 to 0.950, and (iii) the toner has a storage modulus (G′80) at 80° C. of 1×10⁵ to 1×10⁸ Pa, and a ratio of a loss modulus G′ of the toner to the storage modulus G′ of the toner (G″/G′=tan δ) is equal to 1 at a temperature in the range of 60° C. to 72° C.

Furthermore, it is an object of the present invention to provide a method for forming an image by developing an electrostatic latent image formed on an electrophotographic photosensitive member with a toner. In the method for forming an image of the present invention, the following electrophotographic photosensitive member and the toner are used. The electrophotographic photosensitive member comprises at least a conductive support, a photosensitive layer formed on the support, and a surface layer composed of a curing resin, wherein the electrophotographic photosensitive member has a universal hardness (HU) of 1.5×10⁸ to 2.3×10⁸ N/m², the universal hardness being measured in an environment of 25° C. with a humidity of 50% using a Vickers diamond indenter having a quadrangular pyramid shape with a maximum indentation load of 6 mN, and the electrophotographic photosensitive member has an elastic deformation ratio of 46% to 65%. The toner comprises at least a binder resin, a colorant, and a release agent, wherein (i) the toner has a weight average particle diameter (D4) of 4.0 to 8.0 μm, (ii) the average circularity of the toner having an equivalent circle diameter of at least 2 μm is 0.915 to 0.950, and (iii) the toner has a storage modulus (G′80) at 80° C. of 1×10⁵ to 1×10⁸ Pa, and a ratio of a loss modulus G″ of the toner to the storage modulus G′ of the toner (G″/G′=tan δ) is equal to 1 at a temperature in the range of 60° C. to 72° C.

Further objects, features and advantages of the present invention will become apparent from the following description of the preferred embodiments with reference to the attached drawings.

### BRIEF DESCRIPTION OF THE DRAWINGS

FIG. 1 is a schematic cross-sectional view of a surface modification apparatus used in a surface modification process of the present invention.

FIG. 2 is a schematic view showing an example of a top view of a dispersion rotor shown in FIG. 1.

FIG. 3 is an explanatory drawing of a dot pattern used in an evaluation of dot reproducibility.

FIG. 4 is a graph showing an example of data from a hardness evaluation.

FIG. 5A is an explanatory drawing showing a character pattern used in a transfer void evaluation, and FIG. 5B is an explanatory drawing showing an image of the void.

### DESCRIPTION OF THE PREFERRED EMBODIMENTS

An object of the present invention is to make full use of a toner with high durability, the toner having superior dot reproducibility and transfer performance, and in addition, including a release agent that can be fixed at low temperatures. In order to achieve superior dot reproducibility and transfer performance, the present inventors tried to reduce the diameter of the toner and to spheroidize the toner. However, the toner containing a release agent aimed at being fixed at low temperatures and having a low melting point had very high plasticity. As a result, reducing the diameter of the toner and spheroidizing the toner extremely deteriorated the durability and caused filming on the photosensitive member to a significant degree.

Subsequently, the present inventors designed a toner that could maintain tough viscoelasticity against deterioration due to temperature and stress during the process from development to transfer. However, because of the high hardness of the toner particles, flaws were readily formed on a normal photosensitive member. Therefore, the durability of the photosensitive member could not be maintained.

As a result of intensive study, the present inventors have found that the use of a photosensitive member having a specific hardness and elasticity satisfies all characteristics including dot reproducibility, transfer performance, low-temperature fixing property, and high durability.

The photosensitive member and the toner used in the present invention will now be described.

The performance required by an organic electrophotographic photosensitive member includes an improvement in durability against mechanical deterioration. In general, as the amount of deformation due to external stress decreases, the hardness of the film increases. As a matter of course, it is assumed that an electrophotographic photosensitive member having a high pencil hardness or Vickers hardness also has a high durability against mechanical deterioration. However, photosensitive members having such a high measured value of pencil hardness or Vickers hardness do not always have improved durability.

The present inventors have found the following fact and have accomplished the present invention. When the universal hardness HU and the elastic deformation ratio Wo of a surface layer of a photosensitive member are within a specific range, the surface layer is less subject to mechanical deterioration. The universal hardness HU is measured as follows: A hardness test is performed using a Vickers diamond indenter having a quadrangular pyramid shape. The indenter moves down into a sample with a maximum load of 6 mN. The use of an electrophotographic photosensitive member having a universal hardness HU of 1.5×10⁸ to 2.3×10⁸ N/m² and an elastic deformation ratio Wo of 46% to 65% significantly improves the durability against mechanical deterioration. In order to further improve the characteristics, the value of the universal hardness HU is more preferably from 1.6×10⁸ to 2.2×10⁸ N/m².

Even when the universal hardness HU exceeds 2.3×10⁸ N/m², deep flaws are unintentionally generated on the photoreceptor. The reason for this is as follows: For example, when the friction with a cleaning blade is increased at a high temperature, a high pressure is locally applied to the photosensitive member. The pressure is generated by the following reasons: When the elastic deformation ratio Wo is less than 46%, the elastic force of the photosensitive member is insufficient. On the other hand, when the elastic deformation ratio Wo exceeds 65%, despite this value being high, the amount of elastic deformation is decreased. As a result, such a high pressure is locally applied. Accordingly, a high universal hardness HU does not always provide a photosensitive member with optimum characteristics.

When the universal hardness HU is less than 1.5×10⁸ N/m² and the elastic deformation ratio Wo exceeds 65%, scraping and minute flaws are generated. The reason for this is as follows: Even though the elastic deformation ratio Wo is high, the amount of plastic deformation is also increased. Consequently, the paper powder and the toner disposed between a cleaning blade and a charged roller rub against each other to generate such flaws.

The present invention will now be described in more detail with reference to preferable embodiments.

According to the toner used in the present invention, the average circularity of the particles in the toner having an equivalent circle diameter of at least 2 μm is 0.915 to 0.950. The average circularity substantially represents an average circularity of toner base particles. In terms of excellent transfer performance and filming resistance, the average circularity is more preferably 0.920 to 0.945. According to the present invention, the toner base particles are spheroidized within a specific range. As a result, the transfer efficiency is improved without impairing the developing property, and the dot reproducibility is improved. In addition, the advantage of providing fluidity by the addition of an additive is also increased.

When the average circularity is lower than 0.915, the advantage of providing fluidity by the addition of an additive is decreased. Consequently, the fluidity of the toner is decreased and the charge of the toner is not uniform. This phenomenon often decreases the transfer efficiency and the dot reproducibility. On the other hand, when the average circularity exceeds 0.950, a release agent component exudes to the surfaces of the toner. As a result, the toner is unintentionally melted and adhered on the photosensitive drum. Furthermore, cleaning is also difficult. This average circularity can be adjusted by spheroidization of the toner particles.

The circularity of the toner used in the present invention can be adjusted using a specific processing apparatus in which the shape of the toner particles is substantially changed to spherical. Such a process to form the spherical shape of the toner particles provides a high transfer performance. In order to achieve both excellent developing property and fixing property, preferably, the exuding of the release agent to the surfaces of the toner particles is also considered during the spheroidization.

Examples of the spheroidizing apparatus of the toner particle include thermal treatment apparatuses such as the Surfusing System available from Nippon Pneumatic MFG. Co., Ltd., in which the surfaces of particles are spheroidized by thermofusion and hot-air spheroidizing apparatuses available from Hosokawa Micron Corporation; and apparatuses in which the surfaces of the particles are spheroidized by mechanical impact such as Hybridization System available from Nara Machinery Co., Ltd., Turbo Mill available from Turbo Kogyo Co, Ltd., Cryptron available from Kawasaki Heavy Industries Ltd., and Mechanofusion System available from Hosokawa Micron Corporation. Among these apparatuses, when the thermal treatment apparatuses are used, it is difficult to control the exuding of the release agent to the surfaces of the toner particles. In addition, even when apparatuses in which the surfaces of the particles are spheroidized by mechanical impact are used, the release agent readily exudes to the surfaces of the toner particles. The reason for this is as follows: Although there are some differences between these apparatuses, these systems basically provide the toner particles with a mechanical impact, while pulverizing the toner particles. Accordingly, even if the affinity with the binder resin is improved using a specific release agent, new surfaces of the toner particles are exposed during the spheroidization, thereby readily discharging the release agent.

A preferable spheroidizing apparatus to produce the toner used in the present invention will now be specifically described with reference to the drawings.

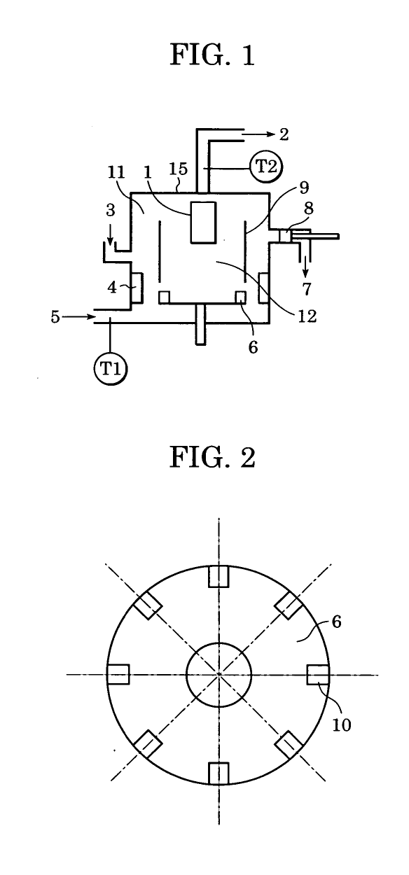

FIG. 1 shows an example of a surface modification apparatus that can be used in the present invention.

The surface modification apparatus shown in FIG. 1 includes a casing 15, a jacket (not shown in the figure) through which cooling water or an antifreeze solution flows, a classification rotor 1, a dispersion rotor 6, a liner 4, a guide ring 9, a fine powder-recovering port 2, a cold air inlet 5, a feeding port 3, a powder-discharging port 7, and an exhaust valve 8. The classification rotor 1 is a classifying device to separate particles into particles having a diameter larger than a predetermined diameter and fine particles having a diameter smaller than or equal to the predetermined diameter. The dispersion rotor 6 is a surface-modifying device to process the surfaces of the particles by providing a mechanical impact. The liner 4 is disposed around the periphery of the dispersion rotor 6 with a predetermined space. The guide ring 9 is a guiding device to guide the particles having a diameter larger than the predetermined diameter, the particles being separated with the classification rotor 1, to the dispersion rotor 6. The fine powder-recovering port 2 is a discharging device to discharge the particles having a diameter smaller than or equal to the predetermined diameter, the particles being separated with the classification rotor 1, to the outside of the apparatus. The cold air inlet 5 is a particle-circulating device to send the surface-modified particles processed with the dispersion rotor 6 to the classification rotor 1. The feeding port 3 introduces the particles to be processed to the casing 15. The powder-discharging port 7 can be freely opened and closed, and is used to discharge the surface-modified particles from the casing 15.

The classification rotor 1 is a cylindrical rotor and is disposed adjacent to one end of the casing 15. The fine powder-recovering port 2 is disposed at the end of the casing 15 such that particles disposed on the inner side of the classification rotor 1 are discharged. The feeding port 3 is disposed at the central part of the periphery of the casing 15. The cold air inlet 5 is disposed at the other end of the periphery of the casing 15. The powder-discharging port 7 is disposed at the periphery of the casing 15 facing the feeding port 3. The exhaust valve 8 is a valve to freely open and close the powder-discharging port 7.

The dispersion rotor 6 and the liner 4 are disposed between the cold air inlet 5, the feeding port 3, and the powder-discharging port 7. The liner 4 is disposed around the inner periphery of the casing 15. As shown in FIG. 2, the dispersion rotor 6 includes a disk and a plurality of rectangular disks 10 disposed along the normal lines of the disk. The dispersion rotor 6 is disposed adjacent to the other end of the casing 15 such that a predetermined space is formed between the liner 4 and the rectangular disks 10. The guide ring 9 is disposed at the central part of the casing 15. The guide ring 9 having a cylindrical shape extends from a position partly covering the periphery of the classification rotor 1 to the vicinity of the dispersion rotor 6. The guide ring 9 forms a first space 11 and a second space 12 in the casing 15. The first space 11 is disposed between the outer periphery of the guide ring 9 and the inner periphery of the casing 15. The second space 12 is an inner space of the guide ring 9.

The dispersion rotor 6 may have columnar pins instead of the rectangular disks 10. According to the present embodiment, the liner 4 includes a large number of grooves on the surface facing the rectangular disks 10. The grooves need not be formed. The classification rotor 1 may be disposed in the longitudinal direction as shown in FIG. 1 or may be disposed in the horizontal direction. The apparatus may include a single classification rotor 1 as shown in FIG. 1, or may include a plurality of classification rotors 1.

The operation of the above surface modification apparatus will now be described. The exhaust valve 8 is closed and a certain number of pulverized particles are charged into the feeding port 3. The pulverized particles are sucked with a blower (not shown in the figure) and classified with the classification rotor 1. During classification, classified fine particles having a diameter smaller than or equal to the predetermined diameter are passed through the periphery of the classification rotor 1 and introduced to the inside of the classification rotor 1. The fine particles are then continuously discharged to the outside of the apparatus. Coarse particles having a diameter larger than a predetermined diameter move with a circulating flow generated by the dispersion rotor 6, while moving along the inner periphery (second space 12) of the guide ring 9 by centrifugal force. Thus, the coarse particles are introduced into a space (hereinafter also referred to as “surface modification zone”) disposed between the rectangular disks 10 and the liner 4. The particles introduced into the surface modification zone undergo a mechanical impact between the dispersion rotor 6 and the liner 4 to perform the surface modification. The resultant surface-modified particles are carried into the classification rotor 1 while moving along the outer periphery (first space 11) of the guide ring 9 with a cold blast passing through the apparatus. Furthermore, fine particles are discharged to the outside of the apparatus with the classification rotor 1. Coarse particles are again returned to the second space 12 as a result of the circulating flow. Again, the coarse particles are subjected to surface modification in the surface modification zone. As described above, the surface modification apparatus shown in FIG. 1 repeats the classification of particles with the classification rotor 1 and the modification of the surfaces of the particles with the dispersion rotor 6. After a predetermined period of time, the exhaust valve 8 is opened to recover the surface-modified particles from the powder-discharging port 7.

The use of the above apparatus barely causes exuding of the release agent by heat. As described above, the use of a known system that provides a mechanical impact causes exuding of the release agent to the surfaces of the toner particles because new surfaces of the toner particles are exposed during the process. The above apparatus can suppress such an exuding of the release agent, compared with the known system. The use of the above apparatus is preferable because the above apparatus can readily control the spheroidization of the toner particles and the exuding of the release agent.

The measurement of the average circularity will now be described. The equivalent circle diameter, the circularity, and frequency distribution are used as a convenient method to quantitatively describe the shape of the toner particles. In the present invention, the above parameters were measured with a flow particle image analyzer FPIA-2100 available from Sysmex Corporation and calculated by the following formulae.

$$Equivalent circle diameter = {( Project area of a particle \text{/} π )}^{1 / 2} \times 2$$

$$Circularity = \frac{\begin{matrix}Perimeter of a circle having the same \\ area as the project area of a particle\end{matrix}}{Perimeter of projection image of the particle}$$

Herein, the term “project area of a particle” is defined as an area of a binarized image of a toner particle. The term “perimeter of projection image of a particle” is defined as a length of the profile line formed by joining edge dots of the image of the toner particle. The circularity in the present invention is an indicator showing the degree of irregularity of the toner particles. The circularity of a toner particle having a perfect spherical shape is 1.00. As the surface configuration becomes more complex, the value of the circularity becomes smaller. In the present invention, a number average diameter of an equivalent circle D1 (μm), which represents an average number-size frequency distribution of the particle diameter of a color toner, and a standard deviation of particle diameter SDd are calculated by the following formulae:

$$\begin{matrix}Number average diameter \\ of equivalent circle D1\end{matrix} = {\sum }_{i = 1}^{n} ( fi \times di ) / {{\sum }^{n}}_{i = 1} ( fi )$$

$$\begin{matrix}Standard deviation of \\ particle diameter SDd\end{matrix} = {\{ {\sum }_{i = 1}^{n} {( D1 - di )}^{2} / {\sum }_{i = 1}^{n - 1} ( fi ) \}}^{1 / 2}$$

wherein di represents particle diameter (central value) and fi represents the frequency at a dividing point i in the particle distribution.

An average circularity C, which represents an average frequency distribution of the circularity, and a standard deviation of circularity SDc are calculated by the following formulae:

$$Average circularity C = {\sum }_{i = 1}^{m} ( Ci \times fci ) / {\sum }_{i = 1}^{m} ( fci )$$

$$\begin{matrix}Standard deviation of \\ circularity SDc\end{matrix} = {\{ {\sum }_{i = 1}^{m} {( C - ci )}^{2} / {\sum }_{i = 1}^{m - 1} ( fci ) \}}^{1 / 2}$$

wherein ci represents circularity (central value) and fci represents the frequency at a dividing point i in the particle distribution.

A measuring method will now be described. In a container, 10 ml of ion-exchange water, wherein impure solid matter had been removed in advance, was prepared. A surface-active agent, which is a dispersant, was added to the ion-exchange water. The surface-active agent is preferably an alkyl benzene sulfonate. A sample (0.02 g) for the measurement was further added to the mixture and was uniformly dispersed. The dispersion was performed with an ultrasonic dispersing device (Tetora 150 available from Nikkaki-Bios Co., Ltd.) for two minutes to prepare the dispersion liquid for the measurement. The dispersion liquid was appropriately cooled so that the temperature of the liquid did not increase to 40° C. or more. In order to suppress the variation in the circularity, the ambient temperature of the flow particle image analyzer FPIA-2100 was controlled at 23° C.+0.5° C. such that the temperature in the analyzer was 26° C. to 27° C. In addition, automatic focusing was performed with latex particles at regular time intervals, preferably at two-hour intervals.

In measuring the circularity of the toner particles, the concentration of the dispersion liquid was controlled again such that the concentration of the toner particles during measurement was 3,000 to 10,000 μl. At least 1,000 toner particles were measured with the flow particle image analyzer. After the measurement, the data from the particles having an equivalent circle diameter of less than 2 μm were cut out. The average circularity of the toner particles was then calculated using the data.

The analyzer FPIA-2100 used in the present invention can analyze fine particles more reliably, compared with FPIA-1000 analyzer, which was previously used to calculate the toner shapes. According to the FPIA-2100 analyzer, a sheath flow has a thin layer structure; in other words, the thickness of a cell wherein a sample solution flows, the cell being disposed between a CCD camera and an electronic flash, is very small. In addition, the magnifying power of images of the processing particles has been improved. The processing resolution of the captured images has also been improved (256×256→512×512). For these reasons, the accuracy of measurement of the toner shape has been improved.

According to the toner used in the present invention, a storage modulus (G′80) at 80° C. is 1×10⁵ to 1×10⁸ Pa. When the value of G′80 is less than 1×10⁵ Pa, the toner is unintentionally melted and adhered on the photoreceptor drum. In contrast, when the value of G′80 exceeds 1×10⁸ Pa, the toner particles are hard and readily pass through a cleaning blade. As a result, fogging is generated and the durability of the photoreceptor is also deteriorated. Furthermore, the low-temperature fixing property is deteriorated.

According to the toner used in the present invention, a ratio of a loss modulus G″ of the toner to the storage modulus G′ of the toner (G″/G′=tan δ) is equal to 1 at a temperature in the range of 60° C. to 72° C. At this temperature, the storage modulus G′ and the loss modulus G′ are equivalent. This temperature represents a glass-transition temperature (Tg) of the toner. When the temperature wherein the value of tan δ is 1 is lower than 60° C., the toner is readily deteriorated. This deterioration decreases the transfer efficiency, and in addition, the toner is readily melted and adhered on the photosensitive drum. When the temperature wherein the value of tan δ is 1 exceeds 72° C., it is difficult for the toner to become spheroidized. As a result, it takes a long time to provide a predetermined circularity in spheroidizing. In addition, the release agent is readily exuded to the surface of the toner. As a result, the toner is melted and adhered on the photoreceptor drum.

The toner particles used in the present invention have a weight average particle diameter (D4) of 4.0 to 8.0 μm. The toner used in the present invention has a fine weight average particle diameter so as to achieve excellent dot reproducibility. However, when the weight average particle diameter is less than 4.0 μm, high transfer performance is difficult to achieve and cleaning is also difficult. On the other hand, when the weight average particle diameter exceeds 8.0 μm, superior dot reproducibility cannot be achieved. The above toner having a fine particle diameter has high durability. This is because the toner has high viscoelasticity at the above low temperature.

The combination of a toner used in the present invention having high viscoelasticity at a low temperature and a photoreceptor that is hard and has a specific degree of elasticity is advantageous in preventing the transfer void. Although the details are not known exactly, according to the probable reasons by the present inventors, the adhesive strength of the toner to the photosensitive member is decreased by hardening the toner and the photosensitive member. In addition, the photosensitive member is subjected to elastic deformation to such an extent that the toner is not subjected to plastic deformation due to the transfer pressure. This elastic deformation decreases the adhesive strength between the toner particles and between the toner and the photosensitive member.

The binder resins used in the present invention will now be described.

The binder resins that can be used in the present invention are commercially available. Examples of the binder resin are selected from (a) polyester resins, (b) hybrid resins including a polyester unit and a vinyl copolymer unit, (c) mixtures of a hybrid resin and a vinyl copolymer, (d) mixtures of a polyester resin and a vinyl copolymer, (e) mixtures of a hybrid resin and a polyester resin, and (f) mixtures of a polyester resin, a hybrid resin, and a vinyl copolymer.

When a polyester resin is used as the binder resin, examples of the monomer include a polyalcohol and either a polycarboxylic acid or a polycarboxylic anhydride, and a polycarboxylate.

Specifically, examples of a dihydric alcohol component include alkylene oxide adducts of bisphenol A such as polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, and polyoxypropylene (6)-2,2-bis(4-hydroxyphenyl)propane; ethylene glycol; diethylene glycol; triethylene glycol; 1,2-propylene glycol; 1,3-propylene glycol; 1,4-bunanediol; neopentyl glycol; 1,4-butenediol; 1,5-pentanediol; 1,6-hexanediol; 1,4-cyclohexanedimethanol; dipropylene glycol; polyethylene glycol; polypropylene glycol; polytetramethylene glycol; bisphenol A; and hydrogenated bisphenol A.

Examples of a trivalent or higher valence alcohol component include sorbitol, 1,2,3,6-hexanetetrol, 1,4-sorbitan, pentaerythritol, dipentaerythritol, tripentaerythritol, 1,2,4-butanetriol; 1,2,5-pentanetriol; glycerol; 2-methylpropanetriol; 2-methyl-1,2,4-butanetriol; trimethylolethane, trimethylolpropane, and 1,3,5-trihydroxymethylbenzene.

Examples of a diacid component include aromatic dicarboxylic acids such as phthalic acid, isophthalic acid, and terephthalic acid and anhydrides thereof; alkyl dicarboxylic acids such as succinic acid, adipic acid, sebacic acid, and azelaic acid and anhydrides thereof; succinic acid having an alkyl substituent of 6 to 12 carbon atoms and anhydrides thereof; and unsaturated dicarboxylic acids such as fumaric acid, maleic acid, and citraconic acid and anhydrides thereof.

Examples of a trivalent or higher valence polycarboxylic acid component, which is used to form a polyester resin having cross-linking portions, include 1,2,4-benzenetricarboxylic acid, 1,2,5-benzenetricarboxylic acid, 1,2,4-naphthalenetricarboxylic acid, 2,5,7-naphthalenetricarboxylic acid, and 1,2,4,5-benzenetetracarboxylic acid the anhydrides thereof, and ester compounds thereof.

Among the above resins, in particular, polyester resins represented by the following chemical formula (i) are preferably used in a color toner because these polyester resins have excellent charging characteristics. In the polyester resins, a biphenyl derivative is used as the diol component, and a carboxylic acid component (for example, fumaric acid, maleic acid, maleic anhydride, phthalic acid, terephthalic acid, trimellitic acid, and pyromellitic acid) composed of a divalent or higher valence carboxylic acid, anhydrides thereof, or lower alkyl esters thereof is used as the acid component. The diol component and the acid component are polymerized by condensation to produce the polyester resin.

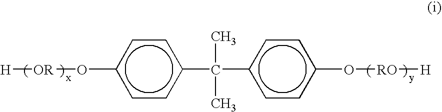

In chemical formula (i), R represents an ethylene group or a propylene group, each of x and y represents an integer of 1 or more, and the average of x+y is 2 to 10.

In the binder resin in the toner used in the present invention, the term “hybrid resin” refers to a resin formed by chemically bonding a vinyl polymer unit and a polyester unit. Specifically, the hybrid resin is formed by transesterification of a polyester unit with a vinyl polymer unit produced by polymerizing a monomer having a carboxylate group, for example, a (meth)acrylate. The hybrid resin is preferably a graft copolymer (or a block copolymer) including a backbone polymer composed of the vinyl polymer and a branch polymer composed of the polyester unit. In the present invention, the term “polyester unit” refers to a portion derived from polyester, and the term “vinyl polymer unit” refers to a portion derived from a vinyl polymer. Polyester monomers forming the polyester unit include a polycarboxylic acid component and a polyalcohol component. Monomer components having a vinyl group form the vinyl polymer unit.

Examples of the vinyl monomer forming the vinyl polymer unit include styrene; styrene derivatives such as o-methylstyrene, m-methylstyrene, p-methylstyrene, α-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene; unsaturated mono-olefins such as ethylene, propylene, butylene, and isobutylene; unsaturated polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; α-methylene aliphatic mono-carboxylic esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethyl amino ethyl methacrylate, and diethyl amino ethyl methacrylate; acrylic esters such as methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, and phenyl acrylate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinyl naphthalenes; and acrylic or methacrylic derivatives such as acrylonitrile, methacrylonitrile, and acrylamide.

Examples of the vinyl monomer further include unsaturated dibasic acids such as maleic acid, citraconic acid, itaconic acid, alkenyl succinic acid, fumaric acid, and mesaconic acid; anhydrides of unsaturated dibasic acids such as maleic anhydride, citraconic anhydride, itaconic anhydride, and alkenyl succinic anhydride; half esters of unsaturated dibasic acids such as methyl maleate half ester, ethyl maleate half ester, butyl maleate half ester, methyl citraconate half ester, ethyl citraconate half ester, butyl citraconate half ester, methyl itaconate half ester, methyl alkenyl succinate half esters, methyl fumarate half ester, and methyl mesaconate half ester; esters of unsaturated dibasic acids such as dimethyl maleate and dimethyl fumarate; α,β-unsaturated acids such as acrylic acid, methacrylic acid, crotonic acid and cinnamic acid; α,β-unsaturated acid anhydrides such as crotonic anhydride and cinnamic anhydride; anhydrides of the α,β-unsaturated acids with lower fatty acids; and monomers having carboxylic group such as alkenyl malonic acid, alkenyl glutaric acid, and alkenyl adipic acid, anhydrides thereof, and monoesters thereof.

Examples of the vinyl monomer further include acrylates or methacrylate such as 2-hydroxyethyl acrylate, 2-hydroxyethyl methacrylate, and 2-hydroxypropyl methacrylate; and monomers having a hydroxy group such as 4-(1-hydroxy-1-methylbutyl) styrene and 4-(1-hydroxy-1-methylhexyl) styrene.

In the toner used in the present invention, the vinyl polymer unit of the binder resin may have a cross-linked structure, which is cross-linked with a cross-linking agent having at least two vinyl groups. Examples of the cross-linking agent used in such a case include aromatic divinyl compounds such as divinylbenzene and divinylnaphthalene; diacrylate compounds bonded with an alkyl chain such as ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and the above compounds whose acrylate moiety is replaced with methacrylate; diacrylate compounds bonded with an alkyl chain containing an ether bond such as diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and the above compounds whose acrylate moiety is replaced with methacrylate; and diacrylate compounds bonded with a chain containing an aromatic group and an ether bond such as polyoxyethylene (2)-2,2-bis(4-hydroxyphenyl)propane diacrylate, polyoxyethylene (4)-2,2-bis(4-hydroxyphenyl)propane diacrylate, and the above compounds whose acrylate moiety is replaced with methacrylate.

Examples of a polyfunctional cross-linking agent include pentaerythritol triacrylate, trimethylolethane triacrylate, trimethylolpropane triacrylate, tetramethylolmethane tetraacrylate, oligoester acrylate, and the above compounds whose acrylate moiety is replaced with methacrylate; triallylcyanurate, and triallyltrimellitate.

In the present invention, at least one of the vinyl polymer unit and the polyester unit preferably includes a monomer component capable of reacting with both components forming the above two resin units. Among monomers forming the polyester unit, examples of a monomer component capable of reacting with the component of the vinyl polymer unit include unsaturated dicarboxylic acids such as fumaric acid, maleic acid, citraconic acid, and itaconic acid, and anhydrides thereof. Among monomers forming the vinyl polymer unit, examples of a monomer component capable of reacting with the component of the polyester unit include monomers having a carboxyl group or a hydroxyl group, acrylates, and methacrylates.

According to a preferable method for preparing the reaction product of the vinyl polymer unit with the polyester unit, at least one of both resins is polymerized in the presence of a polymer containing a monomer component capable of respectively reacting with the vinyl polymer unit and the polyester unit.

Examples of a polymerization initiator to produce the vinyl polymer unit used in the present invention include azo or diazo compounds such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-(carbamoylazo)-isobutyronitrile, 2,2′-azobis(2,4,4-trimethylpentane), 2-phenylazo-2,4-dimethyl-4-methoxyvaleronitrile, and 2,2′-azobis(2-methyl-propane); and ketone peroxides such as methyl ethyl ketone peroxide, acetylacetone peroxide, and cylcohexanone peroxide; as well as 2,2-bis(t-butylperoxy)butane, t-butyl hydroperoxide, cumene hydroperoxide, 1,1,3,3-tetramethylbutyl hydroperoxide, di-t-butyl peroxide, t-butylcumyl peroxide, di-cumyl peroxide, α,α′-bis(t-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, di-isopropyl peroxydicarbonate, di-2-ethylhexyl peroxydicarbonate, di-n-propyl peroxydicarbonate, di-2-ethoxyethyl peroxydicarbonate, di-methoxyisopropyl peroxydicarbonate, di(3-methyl-3-methoxybutyl) peroxydicarbonate, acetylcyclohexylsulfonyl peroxide, t-butyl peroxyacetate, t-butyl peroxyisobutyrate, t-butyl peroxyneodecanoate, t-butyl peroxy-2-ethylhexanoate, t-butyl peroxylaurate, t-butyl peroxybenzoate, t-butyl peroxyisopropylcarbonate, di-t-butyl peroxyisophthalate, t-butyl peroxyallylcarbonate, t-amyl peroxy-2-ethylhexanoate, di-t-butyl peroxyhexahydrophthalate, and di-t-butyl peroxyazelate.

In order to prepare the polyester unit, the acid components and the alcohol components exemplified in the above description of the polyester resin can be used.

Methods for preparing the hybrid resin in the toner used in the present invention include the following production methods shown in (1) to (6).

(1) In a first method, a vinyl polymer and a polyester resin are separately produced and are then blended. In order to synthesize a hybrid resin component, firstly, the above resin components are dissolved and swelled in an organic solvent, for example, a xylene. An esterifying catalyst and an alcohol are added to the mixture, and the mixture is heated to perform transesterification. Subsequently, the organic solvent is removed to produce the hybrid resin component.

(2) In a second method, a vinyl polymer is produced, and a polyester unit and a hybrid resin component are then produced in the presence of the vinyl polymer. The hybrid resin component is produced by a reaction of the vinyl polymer unit (a vinyl monomer may also optionally be added) with a polyester monomer (a polyalcohol and a polycarboxylic acid) or by a reaction of the above vinyl polymer unit with the above polyester monomer and a polyester added according to need. In this case, any organic solvent may appropriately be used.

(3) In a third method, a polyester resin is produced, and a vinyl polymer unit and a hybrid resin component are then produced in the presence of the polyester resin. The hybrid resin component is produced by a reaction of the polyester unit (a polyester monomer may also optionally be added) with a vinyl monomer or by a reaction of the above polyester unit with the above vinyl monomer and a vinyl polymer unit added according to need. In this case, any organic solvent may appropriately be used.

(4) In a fourth method, firstly, a vinyl polymer and a polyester resin are produced. At least one of a vinyl monomer and a polyester monomer (a polyalcohol and a polycarboxylic acid) is then added in the presence of these polymer units. Polymerization is performed under conditions depending on the added monomer or monomers to produce a hybrid resin component. In this case, any organic solvent may appropriately be used.

(5) In a fifth method, a hybrid resin component is produced, and at least one of a vinyl monomer and a polyester monomer (a polyalcohol and a polycarboxylic acid) is then added. At least one of addition polymerization and condensation polymerization is performed to produce a vinyl polymer unit and a polyester unit. In this case, the hybrid resin component produced by the above methods shown in (2) to (4) may be used. Alternatively, a hybrid resin component produced by a known method may be used according to need. Also, any organic solvent may appropriately be used.

(6) In a sixth method, firstly, a vinyl monomer and a polyester monomer (a polyalcohol and a polycarboxylic acid) are mixed. Addition polymerization and condensation polymerization are successively performed to produce a vinyl polymer unit, a polyester unit, and a hybrid resin component. Also, any organic solvent may appropriately be used.

In the above methods shown in (1) to (5), a plurality of polymer units having different molecular weights and different degrees of cross-linking may be used as the vinyl polymer unit and the polyester unit. According to the present invention, the vinyl polymer represents a vinyl homopolymer or a vinyl copolymer, and the vinyl polymer unit represents a vinyl homopolymer unit or a vinyl copolymer unit.

Examples of a black colorant used in the present invention include carbon black, magnetic materials, and colorants toned in black using yellow, magenta and cyan colorants. Unlike the other colorants, when magnetic materials are used as the black colorant, from 30 to 200 parts by weight of the magnetic materials are added to 100 parts by weight of the binder resin.

Examples of the magnetic materials include metal oxides containing iron, cobalt, nickel, copper, magnesium, manganese, aluminum, and silicon. In particular, metal oxides containing an iron oxide as the main component, for example, tri-iron tetroxide and γ-iron oxide are preferably used. In view of controlling the electrostatic property of the toner, the magnetic materials may contain other metallic elements such as silicon and aluminum. The magnetic materials preferably have a BET specific surface area of 2 to 30 m²/g, and more preferably, 3 to 28 m²/g. The BET specific surface area is measured by a nitrogen adsorption method. Furthermore, the magnetic materials preferably have a Mohs' hardness of 5 to 7.

The content of the magnetic material is generally 30 to 200 parts by weight, preferably, 40 to 200 parts by weight, and more preferably, 50 to 150 parts by weight to 100 parts by weight of the binder resin. When the content of the magnetic material is less than 30 parts by weight, the tinting power is insufficient. In addition, in a developing device using a magnetic force to carry the toner, the toner is not carried to a sufficient degree. This phenomenon causes unevenness of a developer layer on a developer carrier, and consequently, causes unevenness of images. Furthermore, the triboelectrification of the developer is increased, thereby decreasing the depth of images. On the other hand, when the content of the magnetic material exceeds 200 parts by weight, the fixing property of the toner is deteriorated.

As colorants for color toners used in the present invention, known dyes and pigments may be used.

Examples of color pigments for a magenta toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209, and 238; C.I. Pigment Violet 19; and C.I. Vat Red 1, 2, 10, 13, 15, 23, 29, and 35.

The pigments may be used alone as colorants. In view of image quality of full color images, the pigments are preferably used in combination with dyes so that color sharpness can be improved.

Examples of dyes for the magenta toner include oil-soluble dyes such as C.I. Solvent Red 1, 3, 8, 23, 24, 25, 27, 30, 49, 81, 82, 83, 84, 100, 109, and 121, C.I. Disperse Red 9, C.I. Solvent Violet 8, 13, 14, 21, and 27, and C.I. Disperse Violet 1; and basic dyes such as C.I. Basic Red 1, 2, 9, 12, 13, 14, 15, 17, 18, 22, 23, 24, 27, 29, 32, 34, 35, 36, 37, 38, 39, and 40, and C.I. Basic Violet 1, 3, 7, 10, 14, 15, 21, 25, 26, 27, and 28.

Examples of color pigments for a cyan toner include C.I. Pigment Blue 2, 3, 15:3, 15:4, 16, and 17; C.I. Vat Blue 6; C.I. Acid Blue 45; and copper phthalocyanine pigments whose phthalocyanine skeleton is replaced with 1 to 5 phthalimide methyl group or groups, which are represented by the following chemical formula: 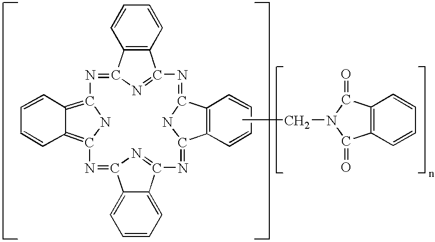
wherein n represents an integer of 1 to 5.

Examples of color pigments for a yellow toner include C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and C.I. Vat Yellow 1, 3, and 20.

Examples of dyes for the yellow toner include C.I. Solvent Yellow 162. The pigments are preferably used in combination with the dyes.

The colorant content is preferably 0.1 to 15 parts by weight, more preferably, 0.5 to 12 parts by weight, and most preferably, 3 to 10 parts by weight to 100 parts by weight of binder resin.

Examples of the release agent used in the present invention include aliphatic hydrocarbon waxes such as low-molecular weight polyethylene, low-molecular weight polypropylene, low-molecular weight alkylene copolymers, microcrystalline wax, paraffin wax, and Fischer-Tropsch wax, oxides of aliphatic hydrocarbon waxes such as polyethylene oxide wax, and block copolymers thereof; waxes composed mainly of a fatty ester, such as ester wax, e.g., behenyl behenate and stearyl stearate, carnauba wax, and montan wax, and agents produced by partly or wholly deoxidizing fatty esters, such as deoxidized carnauba wax. Examples of the release agent further include saturated straight-chain fatty acids such as palmitic acid, stearic acid and montanic acid; unsaturated fatty acids such as brassidic acid, eleostearic acid and parinaric acid; saturated alcohols such as stearyl alcohol, aralkyl alcohols, behenyl alcohol, carnaubyl alcohol, ceryl alcohol and melissyl alcohol; polyalcohols such as sorbitol; fatty acid amides such as linoleic acid amide, oleic acid amide and lauric acid amide; saturated fatty acid bisamides such as methylenebis stearic acid amide, ethylenebis capric acid amide, ethylenebis lauric acid amide and hexamethylenebis stearic acid amide; unsaturated fatty acid amides such as ethylenebis oleic acid amide, hexamethylenebis oleic acid amide, N,N′-dioleyl adipic acid amide, and N,N′-dioleyl sebacic acid amide; aromatic bisamides such as m-xylenebis stearic acid amide and N,N′-distearyl isophthalic acid amide; aliphatic metal salts (those generally called metal soap) such as calcium stearate, calcium laurate, zinc stearate, and magnesium stearate; grafted waxes produced by grafting vinyl monomers such as styrene or acrylic acid to aliphatic hydrocarbon waxes; partly esterified compounds of polyalcohols with fatty acids, such as monoglyceride behenate; and methyl esterified compounds having a hydroxyl group, produced by hydrogenation of vegetable fats and oils.

In particular, aliphatic hydrocarbon waxes are preferably used as a release agent in the present invention. Examples of the aliphatic hydrocarbon wax include low-molecular weight alkylene waxes produced by polymerizing alkylenes by radical polymerization under high pressure or by polymerization under low pressure in the presence of a Ziegler catalyst or a metallocene catalyst, paraffin wax, Fischer-Tropsch wax synthesized from coal or natural gas, alkylene polymers produced by thermal decomposition of high-molecular weight alkylene polymers, and synthetic hydrocarbon waxes produced from, or by hydrogenation of, distillation residues of hydrocarbons prepared by the Arge process from synthetic gases containing carbon monoxide and hydrogen. Hydrocarbon waxes fractionated by press sweating, a solvent fractionation, a vacuum distillation, or a fractionation recrystallization system are more preferably used. Examples of the hydrocarbons, serving as a matrix, include hydrocarbons synthesized by allowing carbon monoxide to react with hydrogen in the presence of a metal oxide catalyst (generally catalysts of a two or more multiple component system), such as hydrocarbon compounds synthesized by the Synthol process or the Hydrocol process (making use of a fluidized catalyst bed); hydrocarbons having about several-hundred carbon atoms produced by the Arge process (making use of a fixed catalyst bed) which provides waxy hydrocarbons in a large quantity; hydrocarbons produced by polymerization of alkylenes such as ethylene in the presence of a Ziegler catalyst; and paraffin wax. These hydrocarbons are preferable as they have fewer and smaller branches and are saturated long straight chain hydrocarbons. In particular, waxes synthesized by a method not relying on the polymerization of alkylenes are preferable in view of their molecular weight distribution.

In the present invention, the toner may include a charge control agent. Any known charge control agent may be used. In particular, metallic compounds of an aromatic carboxylic acid are preferable because such compounds are colorless, provide a high charging speed to the toner, and stably maintain a certain amount of charge.

Examples of negative charge control agents include metallic compounds of salicylic acid, metallic compounds of naphthoic acid, metallic compounds of dicarboxylic acid, polymeric compounds having a sulfonic acid group or a carboxylic acid group in their side chains, boron compounds, urea compounds, silicon compounds, and calixarenes. Examples of positive charge control agents include quaternary ammonium salts, polymeric compounds having the above quaternary ammonium salts in their side chains, guanidino compounds, and imidazole compounds. The charge control agents may be internally added or externally added to the toner particles. The total content of the charge control agents is preferably 0.2 to 10 parts by weight to 100 parts by weight of the binder resin.

The toner used in the present invention includes an additive agent to improve the fluidity.

Inorganic fine particles composed of silicates, titanium oxide, and aluminum oxide are preferably used as the additive agent. The inorganic fine particles are preferably hydrophobized with a hydrophobing agent such as a silane compound, silicone oil, or a mixture thereof.

The content of the additive agent is generally 0.1 to 5 parts by weight to 100 parts by weight of the toner particle. The present invention is also very useful in terms of nonmagnetic one-component development and nonmagnetic two-component development. Fine particles composed of titanium oxide are preferably used as the additive agent when the toner particles are nonmagnetic color toner particles to form full color images.

The toner particles and the additive agent are mixed with a known mixer such as a Henschel mixer.

When the toner in the present invention is used as a two-component developer, the toner is mixed with a magnetic carrier. Examples of the magnetic carrier include particles of metals such as iron, nickel, copper, zinc, cobalt, manganese, chromium, and rare earth elements, the surface of the metals being oxidized or the metals being not oxidized, alloys or oxides of any of these, and ferrite.

The surfaces of the magnetic carrier particles may be coated with a resin. In particular, the coated carrier is preferably used in a developing method in which an alternating current bias is applied to a developing sleeve. Any known method may be used to coat the carrier: A coating material such as a resin may be dissolved or suspended in a solvent to prepare a coating solution. Subsequently, the coating solution may be coated on the surfaces of the magnetic carrier particles. Alternatively, the magnetic carrier particles and the coating material may be mixed in a powder state.

Examples of the coating material to coat the surfaces of the magnetic carrier particles include silicone resins, polyesters, polystyrenes, acrylic resins, polyamides, polyvinyl butyral, and aminoacrylates. These resins may be used alone or in combination of two or more.

The content of the coating material is preferably 0.1 to 30 mass percent, and more preferably, 0.5 to 20 mass percent of the magnetic carrier particles. The magnetic carrier preferably has an average particle diameter of 10 to 100 μm, and more preferably, 20 to 70 μm.

When the toner used in the present invention is mixed with the magnetic carrier to prepare the two-component developer, the content of the toner in the developer is generally 2 to 15 mass percent, and more preferably, 4 to 13 mass percent. This mixing ratio provides good results.

The electrophotographic photoreceptor used in the present invention and the method for producing the photoreceptor will now be described in detail. The electrophotographic photosensitive member has a universal hardness HU of 150 to 230 N/mm² and an elastic deformation ratio Wo of 46% to 65%. To measure the universal hardness HU, a hardness test is performed in an environment of 25° C. with a humidity of 50%, using a Vickers diamond indenter having a quadrangular pyramid shape with a maximum indentation load of 6 mN.

The electrophotographic photosensitive member used in the present invention preferably has a layered structure in the main part. The electrophotographic photosensitive member used in the present invention includes a support, a charge generation layer disposed on the support, and a charge transportation layer disposed on the charge generation layer. A protective layer is further disposed on the top face. A binder layer, and in addition, an undercoat layer that prevents interference fringe may be disposed between the support and the charge generation layer.

For example, the support may be composed of a conductive material such as aluminum, an aluminum alloy, or stainless steel. The support may be composed of the above conductive materials or a plastic having a layer composed of aluminum, an aluminum alloy, or an indium oxide-tin oxide alloy formed by vacuum deposition. The support may be produced by impregnating a plastic or paper with conductive fine particles (for example, carbon black, tin oxide, titanium oxide, and silver particles) and an adequate binder resin. The support may be composed of a plastic containing a conductive binder resin.

The binder layer (bonding layer) having a barrier function and a bonding function may be disposed between the support and the photosensitive layer, i.e., charge generation layer. The binder layer is formed for the purpose of, for example, improved adhesion of the photosensitive layer thereon, improved coating property, protection of the support, coating of defects of the support, improved charge injection from the support, or protection of the photosensitive layer from electrical breakage. The binder layer is composed of, for example, casein, polyvinyl alcohol, ethyl cellulose, ethylene-acrylic acid copolymer, polyamides, modified polyamides, polyurethanes, gelatin, or aluminum oxide. The binder layer preferably has a thickness of 5 μm or less, and more preferably, 0.1 to 3 μm.

Examples of a charge-generating substance used in the present invention include (1) azo pigments such as monoazo, disazo, and trisazo pigments, (2) phthalocyanine pigments such as metal phthalocyanine and nonmetal phthalocyanine pigments, (3) indigo pigments such as indigo and thioindigo pigments, (4) perylene pigments such as anhydrides of perylene and acid imides of perylene, (5) polycyclic quinone pigments such as anthraquinone and pyrene quinine, (6) squarylium dyes, (7) pyrylium salts and thiapyrylium salts, (8) triphenylmethane dyes, (9) inorganic substances such as selenium, selenium-tellurium, and amorphous silicon, (10) quinacridone pigments, (11) azulenium salts pigments, (12) cyanine dyes, (13) xanthene dyes, (14) quinoneimine dyes, (15) styryl dyes, (16) cadmium sulfide, and (17) zinc oxides.

Examples of the binder resin used in the charge generation layer include polycarbonates, polyesters, polyarylates, butyral resins, polystyrene, polyvinyl acetals, diallyl phthalate resin, acrylate resins, methacrylate resins, polyvinyl acetate, phenolic resins, silicone resins, polysulfones, styrene-butadiene copolymer, alkyd resins, epoxy resins, urea resins, and vinyl chloride-vinyl acetate copolymer. The binder resin is not limited to the above. These resins are used alone or in combination of two or more as a single polymer, a mixture of these, or copolymer of these.

The solvent used in the coating material for the charge generation layer is selected according to the resin used, the solubility or the dispersion stability of the charge-generating substance. Examples of the organic solvent include alcohols, sulfoxides, ketones, ethers, esters, aliphatic halogenated hydrocarbons, and aromatic compounds.

The above charge-generating substance is sufficiently dispersed with 0.3 to 4 times by mass of the binder resin and the solvent using a homogenizer, ultrasonic waves, a ball mill, a sand mill, an attritor, or a roll mill. The resultant mixture is then applied and dried to form the charge generation layer. The charge generation layer preferably has a thickness of 5 μm or less, and more preferably, 0.01 to 1 μm.

Various sensitizers, anti-oxidants, ultraviolet absorbers, plasticizers, and known charge-generating substances may be added to the charge generation layer according to need.

Examples of a charge-transporting substance used include various triarylamine compounds, hydrazone compounds, styryl compounds, stilbene compounds, pyrazoline compounds, oxazole compounds, thiazole compounds, and triarylmethane compounds.

Examples of the binder resin forming the charge transportation layer include resins selected from acrylate resins, styrene resins, polyester, polycarbonates, polyarylates, polysulfones, polyphenylene oxide, epoxy resins, polyurethanes, alkyd resins, and unsaturated resins. In particular, polymethylmethacrylate, polystyrene, styrene-acrylonitrile copolymer, polycarbonates, and diallyl phthalate resin are preferably used.

The charge transportation layer is generally formed by dissolving the charge-transporting substance and the binder resin in a solvent, and by applying the mixed solution. The mixing ratio (mass ratio) of the charge-transporting substance to the binder resin is about 2:1 to about 1:2. Examples of the solvent include ketones such as acetone and methyl ethyl ketone; esters such as methyl acetate and ethyl acetate; aromatic hydrocarbons such as toluene and xylenes; chlorinated hydrocarbons such as chlorobenzene, chloroform, and carbon tetrachloride; and ethers such as tetrahydrofuran and dioxane. The solution is applied by, for example, dip coating, spray coating, or spin coating. The coated layer is preferably dried at a temperature range of 10° C. to 2000C, and more preferably, 20° C. to 1500C. The drying time is preferably 5 minutes to 5 hours, and more preferably, 10 minutes to 2 hours using an air-blow system or static drying.

The charge transportation layer is electrically connected with the above charge generation layer. The charge transportation layer receives charge carriers injected from the charge generation layer as a result of an electric field, and transports the charge carriers to the interface with the protective layer. Because of a limit in terms of transportation of the charge carriers, the charge transportation layer does not have a thickness that is any more than necessary. The thickness of the charge transportation layer is preferably 5 to 40 μm, in particular, 7 to 30 μm.

Furthermore, anti-oxidants, ultraviolet absorbers, plasticizers, and known charge-transporting substances may be added to the charge transportation layer according to need.

The protective layer is further applied on the charge transportation layer and is then cured to form the photosensitive member used in the present invention. The photosensitive member has a universal hardness HU of 1.5×10⁸ to 2.3×10⁸ N/m² and an elastic deformation ratio Wo of 46% to 65%. The universal hardness HU is measured in an environment at 25° C. with a humidity of 50%, using a Vickers diamond indenter having a quadrangular pyramid shape with a maximum indentation load of 6 mN.

An example of the protective layer of the electrophotographic photosensitive member that satisfies the above requirements includes a polymer of a hole-transporting compound having at least two chain-polymerizable groups present in its molecule represented by chemical formula (ii): 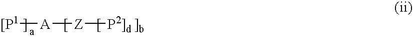
wherein A represents a hole-transporting group; P¹ and P² independently represent a chain-polymerizable group; P¹ and P² may be identical or different; Z represents an organic residue that may have a substituent; a, b, and d independently represent an integer of at least 0; a+b×d represents an integer of at least 2; when a is at least 2, P¹ may be identical or different; when d is at least 2, P² may be identical or different; when b is at least 2, Z and p² may be identical or different.

In chemical formula (ii), A represents a hole-transporting group. Any group having a hole-transporting ability may be used as the hole-transporting group. A preferable example of the group is represented by chemical formula (iii): 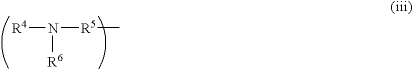
wherein R⁴, R⁵, and R⁶ independently represent an alkyl group of 1 to 10 carbon atoms such as a methyl, an ethyl, a propyl, or a butyl group that may have a substituent; an aralkyl group such as a benzyl, a phenethyl, a naphthylmethyl, a furfuryl, or a thienyl group that may have a substituent; or an aryl group such as a phenyl, a naphthyl, an anthryl, a phenanthryl, a pyrenyl, a thiophenyl, a furyl, a pyridyl, a quinolyl, a benzoquinolyl, a carbazolyl, a phenothiazinyl, a benzofuryl, a benzothiophenyl, a dibenzofuryl, or a dibenzothiophenyl group that may have a substituent; but at least two of R⁴, R⁵, and R⁶ represent an aryl group, and R⁴, R⁵, and R⁶ may be identical or different.

In chemical formula (ii), Z represents an alkylene group that may have a substituent, an arylene group that may have a substituent, CR¹═CR² (wherein each of R¹ and R² represents an alkyl group, an aryl group, or a hydrogen atom, and R¹ and R² may be identical or different), C═O, S═O, SO₂, or an organic residue represented by any combination of at least one element selected from an oxygen atom and a sulfur atom.

The chain-polymerizable group in the present invention will now be described. Reactions for producing a polymer are broadly divided into chain polymerization and successive polymerization. The chain polymerization in the present invention refers to the former polymerization reactions. More specifically, as described in, for example, “Kiso: Gousei Jyushi no Kagaku (Fundamentals: Chemistry of Synthetic Resin) (New Edition)” written by Tadahiro Miwa and published from Gihodo Shuppan Co., Ltd. (Jul. 25, 1995) (First Edition, 8th Printing, p. 24), the chain polymerization represents a polymerization reaction including unsaturation polymerization, ring-opening polymerization, and isomerization polymerization wherein the polymerization proceeds mainly via intermediates, for example, radicals or ions.

The chain-polymerizable group P in chemical formula (ii) represents a functional group that allows the above polymerizations. A preferable chain-polymerizable group P in the present invention is represented by chemical formula (1): 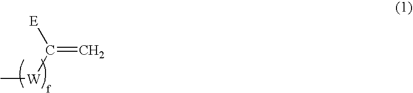
wherein E represents a hydrogen atom, a halogen atom, an alkyl group that may have a substituent, an aryl group that may have a substituent, a cyano group, a nitro group, an alkoxy group, —COOR¹ (wherein R¹ represents a hydrogen atom, a halogen atom, an alkyl group that may have a substituent, an aralkyl group that may have a substituent, or an aryl group that may have a substituent), or —CONR²R³ (wherein R² and R³ independently represent a hydrogen atom, a halogen atom, an alkyl group that may have a substituent, an aralkyl group that may have a substituent, or an aryl group that may have a substituent, and R² and R³ may be identical or different); W represents a divalent arylene group that may have a substituent, a divalent alkylene group that may have a substituent, —COO—, —C—, —O—, —OO—, —S—, or —CONR⁴—(wherein R⁴ represents a hydrogen atom, a halogen atom, an alkyl group that may have a substituent, an aralkyl group that may have a substituent, or an aryl group that may have a substituent); and f represents 0 or 1.

In particular, the chain-polymerizable group P in chemical formula (ii) is preferably represented by any one of chemical formulae (2) to (6):

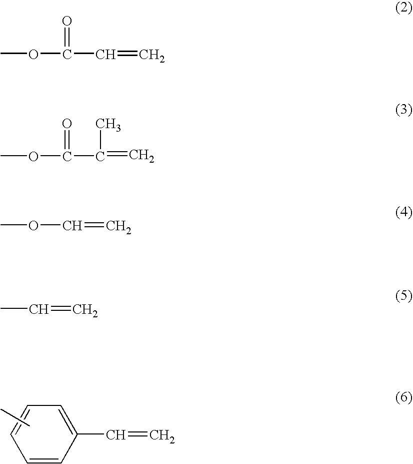

In the protective layer according to the present invention, the hole-transporting compound having at least two chain-polymerizable groups present in its molecule is polymerized with at least two cross-linking points by covalent bonds to form a three-dimensional cross-linked structure. The hole-transporting compound may be polymerized alone or in combination with another compound having a chain-polymerizable group. Any kind of the other compound and any mixing ratio may be selected. Herein, the other compound having a chain-polymerizable group includes any of monomers, oligomers, and polymers having a chain-polymerizable group. When the hole-transporting compound and the other chain-polymerizable compound have functional groups that are identical or mutually polymerizable with each other, these compounds can form a copolymerized three-dimensional cross-linked structure via covalent bonds. When the functional groups of these compounds are those which are not polymerizable with each other, the photosensitive layer is formed of a mixture of at least two three-dimensional cured products or a matrix of a main three-dimensionally cured product containing another chain-polymerizable compound monomer or a cured product thereof. In this case, an inter-penetrating network (IPN) structure may be formed by optimizing the mixing ratio and the layer-forming method.

In the present invention, the protective layer includes a lubricant composed of at least one compound selected from a group consisting of fluorine atom-containing resins, fluorocarbons, and polyolefins. Although the following compounds are preferably used, the compounds are not limited to the compounds.

Examples of the fluorine atom-containing resin preferably include polymers, copolymers, and resin fine particles of the compounds selected from vinyl fluoride, vinylidene fluoride, chlorotrifluoroethylene, tetrafluoroethylene, hexafluoropropylene, perfluoropropylene, and perfluoroalkylvinylethers.

Examples of the fluorocarbon include compounds represented by (CF)ₙ or (C₂F)ₙ.

Examples of the polyolefin preferably include homopolymers such as polyethylene, polypropylene, and polybutene; copolymers such as ethylene-propylene copolymer and ethylene-butene copolymer; and resin fine particles of these.

These lubricants may be used alone or in combination of two or more in any mixing ratio.

The protective layer may further include a dispersant or a dispersing aid of the lubricant, other various additives, and a surface-active agent.

As described above, the protective layer includes a lubricant composed of at least one compound selected from fluorine atom-containing resins, fluorocarbons, and polyolefins. Such a lubricant improves the slipping property and water-repellency of the surface of the photoreceptor. As a result, this lubricant prevents a decrease in the transfer efficiency, the slipping property, and electrical properties such as sensitivity and the electrical potential caused by chemical deterioration of the surface layer due to repeated charging, development, and transfer. Accordingly, even when used repeatedly, this photoreceptor prevents filming, melting and adhering of the toner, cleaning defects, and image defects such as an image blur and image flowing. In particular, the use of fluorine atom-containing resins provides more preferable results.

In the present invention, the lubricant content in the protective layer is preferably 1% to 70%, and more preferably, 5% to 50% to the total mass of a layer that becomes the surface layer. When the lubricant content exceeds 70%, the mechanical strength of the surface layer is decreased. On the other hand, when the lubricant content is less than 1%, the water-repellency and slipping property of the surface layer are not sufficient.

In the present invention, the protective layer, which contains a cured product of a hole-transporting compound having chain-polymerizable groups, may include a charge-transporting substance.

In general, a solution containing the hole-transporting compound is applied and then polymerized to form the protective layer. Alternatively, the solution containing the hole-transporting compound may be polymerized in advance to prepare the cured product. Subsequently, the cured product is dispersed or dissolved in a solvent again to form the protective layer. Such a solution is coated by, for example, dip coating, spray coating, curtain coating, or spin coating, but dip coating is preferable in view of the efficiency and productivity.

In the present invention, the above hole-transporting compound having chain-polymerizable groups is preferably polymerized by exposure to radiation. A major advantage of radiation polymerization is that it does not require a polymerization initiator. As a result, a very high-purity three-dimensionally cured photosensitive layer can be produced, thus providing superior electrophotographic characteristics. Furthermore, because of a quick and effective polymerization reaction, the radiation polymerization provides a high productivity. In addition, because of high transmittance of radiation, even when the layer is thick or contains various additives capable of acting as shielding materials, the layer can be cured without significant retardation thereby. However, in some cases, polymerization is retarded depending on the kind of chain-polymerizable group and the central skeleton of compounds. In such a case, a polymerization initiator may be added in an amount that does not cause adverse effects. The radiation used for the above purpose includes electron beam and γ rays. In the electron beam radiation, any accelerator such as a scanning type, an electro-curtain type, a broad beam type, a pulse type, and a laminar type may be used. In the electron beam radiation, it is very important to optimize irradiation conditions so that the photoreceptor of the present invention has sufficient electrical properties and durability. In the present invention, the accelerating voltage is preferably 250 kV or less, and more preferably, 150 kV or less. The irradiation dose is preferably in the range of 10 to 1,000 kGy. When the accelerating voltage exceeds the above, the electron beam radiation damages the characteristics of the photoreceptor. When the irradiation dose is below the above range, the curing is insufficient. On the other hand, an excessive irradiation dose deteriorates the characteristics of the photoreceptor. <Method for Measuring Surface Physical Properties of a Photosensitive Member>

A photosensitive member for a hardness test, which was prepared as described above, was left to stand in an environment of 25° C. with a humidity of 50% for 24 hours. Subsequently, the universal hardness HU and the elastic deformation ratio Wo were measured with a Fischerscope H100V micro-hardness tester manufactured by Fischer.

Using the micro-hardness tester (Fischerscope H100V manufactured by Fischer) to measure the universal hardness HU and the elastic deformation ratio Wo in the present invention, a load is continuously applied to an indenter, and continuous hardness can be measured by directly reading the indentation depth under the load. A Vickers diamond indenter having a quadrangular pyramid shape was used in the measurement. An angle between the opposite faces at the tip of the indenter was 136 degrees. The hardness was measured stepwise (273 stepwise measurements, each step having a holding time of 0.1 seconds) until a final load of 6 mN was applied.

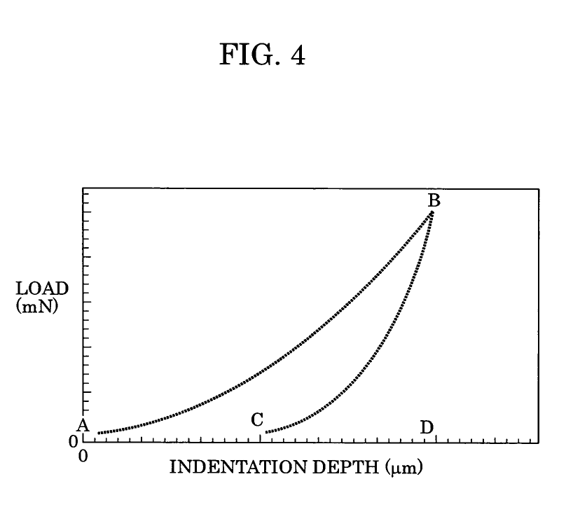

FIG. 4 shows an outline of data from the hardness evaluation. The ordinate represents the load (mN), whereas the abscissa represents the indentation depth h (μm). In the measurement shown in FIG. 4, the load was increased stepwise until the load became 6 mN, the load was then decreased stepwise in the same way.

The universal hardness HU is defined by the following formula (1) with an indentation depth under a load of 6 mN, which was measured by indenting with a load of 6 mN.

$$HU = \frac{Test load ( N )}{ \begin{matrix}Suface area of Vickers \\ indenter under the test load ( mm )\end{matrix}} \\ = \frac{0.006}{26.11 h } ( N / nm ) \qquad ( 1 )$$

h: Indentation depth (mm) under the test load

The elastic deformation ratio Wo was calculated based on a workload (energy) applied by the indenter on the film, in other words, the change in energy due to increasing and decreasing the load applied by the indenter on the film. The value of the elastic deformation ratio Wo is calculated by the following formula (2):
Elastic deformation ratio Wo=We/Wt×100(%) (2)
wherein Wt (nW) represents a total workload indicated by the area surrounded by A-B-D-A in FIG. 4, and We (nW) represents a workload for elastic deformation indicated by the area surrounded by C-B-D-C in FIG. 4.

Preferable methods for measuring the physical properties of a toner used in the present invention will now be described.

<Measurement of Particle Size Distribution of a Toner>

In the present invention, the average particle diameter and the particle size distribution of a toner are measured with a Coulter Counter TA-II manufactured by Coulter. A Coulter Multisizer manufactured by Coulter may also be used. An aqueous solution of 1% NaCl is used as an electrolyte solution for the measurement. The aqueous solution of 1% NaCl may be prepared with first-grade sodium chloride or a commercially available reagent such as ISOTON R-II available from Coulter Scientific Japan.

In the measurement, as a dispersant, a surface-active agent, preferably an alkyl benzene sulfonate (0.1 to 5 ml), is added to the above electrolyte solution (100 to 150 ml). A sample (2 to 20 mg) for the measurement is further added to the mixture. The resultant electrolyte solution containing the suspended sample is subjected to dispersion treatment with an ultrasonic dispersing device for 1 to 3 minutes. Volume distribution and number distribution are calculated by measuring the volume and number of toner particles having a diameter of 2.00 μm or more using a 100 μm aperture in the above analyzer. Thus, the weight average particle diameter (D4) is measured, wherein the median in each channel is defined as the representative value in the channel.

The following 13 channels are used: 2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

<Measurement of the Viscoelasticity of the Toner>

The toner is pressed to form a disc sample having a diameter of 8 mm and a thickness of about 3 mm. The sample is then set in a parallel plate. The temperature is gradually increased in the range of 50° C. to 180° C. to perform temperature dispersion measurement. The temperature is increased at a rate of 2° C./minute, the angular frequency (ω)) is fixed to 6.28 radian/second, and the distortion factor and the correction of sample elongation are automatically controlled. The abscissa represents temperature, whereas the ordinate represents storage modulus (G′). A value at each temperature is read from the graph. An ARES rheometer manufactured by Rheometrics is used for the measurement.

<Measurement of Glass Transition Temperature (Tg) of a Binder Resin>

A glass transition temperature is measured according to ASTM D3418-82 with a differential scanning calorimeter (DSC) DSC-7 manufactured by PerkinElmer. A sample (5 to 20 mg, preferably 10 mg) for the measurement is precisely weighed, and the sample is then put in an aluminum pan. An empty aluminum pan is used as a reference. The measurement is performed in an environment of normal temperature with normal humidity. The temperature is increased at a rate of 10° C./minute, and the measurement is performed in the temperature range of 30° C. to 200° C. During the temperature increase, a main endothermic peak appears in a temperature range of 40° C. to 100° C. A baseline is formed by joining the starting point with the end point of the endothermic peak. A perpendicular line that includes the midpoint of the baseline is dropped. The intersection where the perpendicular line and the differential thermal curve cross is defined as the glass transition temperature (Tg) in the present invention.

<Measurement of Gel Permeation Chromatography>

The molecular weight from a chromatogram by gel permeation chromatography (GPC) is measured under the following conditions.

A column is stabilized in a heat chamber at 40° C. Tetrahydrofuran (THF), which is a solvent, flows through the column at this temperature at a rate of 1 ml/minute. A THF solution of a sample resin is prepared so as to have a concentration of 0.05 to 0.6 mass percent. This solution (about 50 to about 200 μl) is injected to measure the molecular weight. A refractive index (RI) detector is used as a detector. In order to precisely measure molecular weights in the range of 10³ to 2×10⁶, a plurality of commercially available polystyrene gel columns are preferably used in combination. Examples of the combination include Shodex GPC KF-801, 802, 803, 804, 805, 806, and 807, all of which are manufactured by Showa Denko K.K.; and μ-Styragel 500, 10³, 10⁴, and 10⁵, all of which are manufactured by Waters Corporation.

In order to measure the molecular weight of a sample, a calibration curve is prepared with several kinds of standard samples composed of monodispersed polystyrene. The molecular-weight distribution of the sample is calculated using the relationship between the logarithm and the number of counts (retention time) in the calibration curve. Examples of the standard sample used to prepare the calibration curve include standard polystyrenes manufactured by Tosoh Corporation or Pressure Chemical Co. having a molecular weight of 6×10², 2.1×10³, 4×10³, 1.75×10⁴, 5.1×10⁴, 1.1×10⁵, 3.9×10⁵, 8.6×10⁵, 2×10⁶, and 4.48×10⁶. At least about 10 kinds of standard polystyrene samples are preferably used.

### EXAMPLES

Although the present invention will now be specifically described with reference to production examples and Examples, these examples do not limit the present invention.

(Production Examples of Polyesters 1, 2, and 3)

In a four-liter four-neck flask composed of glass, polyoxypropylene (2.2)-2,2-bis(4-hydroxyphenyl)propane (30 parts by weight), polyoxyethylene (2.2)-2,2-bis(4-hydroxyphenyl)propane (10 parts by weight), terephthalic acid (20 parts by weight), trimellitic anhydride (3 parts by weight), fumaric acid (27 parts by weight), and dibutyltin oxide were charged. A thermometer, a stirrer, a condenser, and a nitrogen inlet tube were attached to the four-neck flask, and this four-neck flask was then disposed in a mantle heater. The reaction was performed at 210° C. for about 5.5 hours in a nitrogen atmosphere to produce Polyester 1. Furthermore, Polyesters 2 and 3 were produced by changing the monomer composition. Table 1 shows the measurement results of the molecular weights by GPC of the resultant Polyesters 1, 2, and 3.

(Production Example of a Hybrid Resin)

In a dropping funnel, styrene (10 parts by weight), 2-ethylhexyl acrylate (5 parts by weight), fumaric acid (2 parts by weight), and α-methylstyrene dimer (5 parts by weight), all of which were monomers that form vinyl copolymer units, and di-cumyl peroxide were prepared. In a four-liter four-neck flask composed of glass, polyoxypropylene (2.2)-2,2-bis(4-hydroxyphenyl)propane (25 parts by weight), polyoxyethylene (2.2)-2,2-bis(4-hydroxyphenyl)propane (15 parts by weight), succinic acid (11 parts by weight), trimellitic anhydride (3 parts by weight), and fumaric acid (24 parts by weight), all of which were monomers that form polyester units, and dibutyltin oxide were charged. A thermometer, a stirrer, a condenser, and a nitrogen inlet tube were attached to the four-neck flask, and this four-neck flask was then disposed in a mantle heater. The atmosphere in this four-neck flask was replaced with nitrogen gas, and the temperature was then gradually increased while stirring. The monomers to form the vinyl copolymer units and the initiator were added dropwise from the dropping funnel for about 4 hours at 130° C. while stirring. The temperature was then increased to 200° C. and polymerization was performed for about 4 hours to prepare a hybrid resin. Table 1 shows the measurement results of the molecular weight by GPC of the hybrid resin.

(Toner-Producing Method 1)

Toner materials shown in Tables 2 and 3 were preliminarily mixed with a Henschel mixer to a sufficient degree, and the mixture was then kneaded by melting with a double screw extruder. The mixture was cooled, and was then roughly crushed with a hammer mill such that the particles had a diameter of about 1 to 2 mm. Subsequently, the particles were pulverized with an air-jet pulverizing mill. Furthermore, the pulverized product was subjected to surface treatment with a surface modification apparatus shown in FIGS. 1 and 2. The surface treatment was performed at a revolution speed of the dispersion rotor of 100 s⁻¹ (a peripheral velocity due to the rotation of 130 m/second) for 45 seconds while fine particles were being removed at a revolution speed of the classification rotor of 120 s⁻¹. In other words, after the pulverized product was charged from the feeding port 3, the treatment was performed for 45 seconds. Subsequently, the exhaust valve 8 was opened to discharge the processed product. In this production, ten rectangular discs were disposed on the upper part of the dispersion rotor 6. The space between the guide ring 9 and the rectangular discs disposed on the dispersion rotor 6 was 30 mm, and the space between the dispersion rotor 6 and the liner 4 was 5 mm. The air flow of a blower was 14 m³/minute. The temperature of a refrigerant that passed through the jacket and the temperature T1 of cold air were controlled to −20° C.

This operation was repeated for 20 minutes. During the operation, the temperature T2 at the rear of the classification rotor was maintained at 26° C. Thus, toner resin particles having a weight average particle diameter (D4) of 6.2 μm were prepared.

The toner resin particles (100 parts by weight) were mixed with needle-shaped titanium MT-100T manufactured by Tayca Corporation (1.5 parts by weight) to produce Toner 1 (Cyan toner 1). Furthermore, the Toner 1 was mixed with magnetic manganese magnesium ferrite carrier particles (average particle diameter: 50 μm), the surfaces of which were coated with a silicone resin, such that the toner concentration was 7 mass percent. Thus, a two-component Developer 1 (Cyan developer 1) was produced. Toners 2 to 16 and Developers 2 to 16 were produced by changing the toner materials, particle diameters of the pulverized powder, and conditions for the surface modification apparatus.

(Production Example of a Photosensitive Member)

An aluminum cylinder (JIS A3003 aluminum alloy) having a length of 340 mm and a diameter of 60 mm was used as a supporter. A methanol solution of a polyamide resin (trade name: Amilan CM8000, manufactured by Toray Industries, Inc., 5 mass percent) was applied on the support by dipping to form an undercoat layer having a thickness of 0.5 μm.

Subsequently, a coating material for a charge generation layer was prepared as follows: Crystals of hydroxygallium phthalocyanine were used as a charge-generating substance in which a diffraction angle 2θ±0.2 in X-ray diffraction with CuKα had the strongest peak at 28.10. The crystals of hydroxygallium phthalocyanine (3 parts by weight) and polyvinyl butyral (2 parts by weight) were added to cyclohexanone (100 parts by weight). The mixture was dispersed with a sand mill using glass beads having a diameter of 1 mm for one hour. Methyl ethyl ketone (100 parts by weight) was added to dilute the mixture. The resultant coating material for a charge generation layer was applied on the undercoat layer by dipping, and was then dried at 90° C. for 10 minutes. Thus, a charge generation layer having a thickness of 0.17 μm was formed.

Subsequently, a charge-transporting compound (7 parts by weight) represented by chemical formula (Iv): 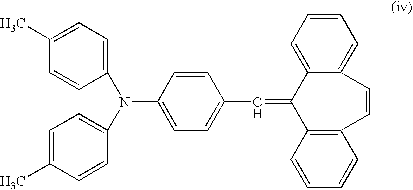
and a polycarbonate (Iupilon Z400 manufactured by Mitsubishi Engineering-Plastics Corporation, 10 parts by weight) were dissolved in monochlorobenzene (105 parts by weight) and dichloromethane (35 parts by weight). The resultant solution was applied on the charge generation layer by dipping, and was then dried with hot air at 110° C. for one hour. Thus, a charge transportation layer having a thickness of 13 μm was formed.

In this example, reversal development was used. As described above, the photosensitive member, i.e., an organic photosensitive member, was formed by laminating the above three layers on the aluminum cylinder having a diameter of 60 mm. This organic photosensitive member further includes a surface protective layer, i.e., protective layer, formed on the charge transportation layer. A compound in the protective layer is formed by polymerizing a hole-transporting compound represented by chemical formula (v): 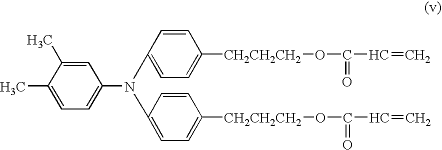
having the following polymerizable group (2): 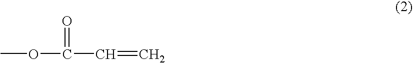
with electron beam radiation.

A coating material for a protective layer was prepared as follows: The above hole-transporting compound (45 parts by weight) was dissolved in n-propyl alcohol (55 parts by weight). Fine particles of tetrafluoroethylene (5 parts by weight) were further added to the solution. The resultant mixture was dispersed with a high-pressure dispersing device (Microfluidizer manufactured by Microfluidics). This coating material was applied on the above photosensitive member, and was irradiated with an electron beam with an accelerating voltage of 150 kV and an irradiation dose of 40 kGy to form a protective layer having a thickness of 3 μm. Thus, Electrophotographic photosensitive member A was produced. The Electrophotographic photosensitive member A was processed so as to be installed in a color copying machine CLC-1000 manufactured by CANON KABUSHIKI KAISHA. This photosensitive member had a universal hardness HU of 1.9×10⁸ N/m² and an elastic deformation ratio Wo of 55%.

An Electrophotographic photosensitive member B was produced in the same way. The Electrophotographic photosensitive member B also had the same values of universal hardness HU and elastic deformation ratio Wo as those of the Electrophotographic photosensitive member A. The Electrophotographic photosensitive member B was processed so as to be installed in a Creative Processor 660 manufactured by CANON KABUSHIKI KAISHA.

Furthermore, an Electrophotographic photosensitive member r C was produced in the way as the Electrophotographic photosensitive member A, except that the hole-transporting compound was replaced with a compound represented by chemical formula (vi): 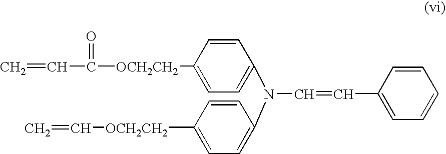
having the following polymerizable groups (2) and (4): 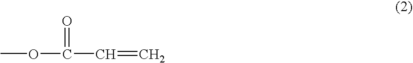 —O—CH═CH₂ (4)

The Electrophotographic photosensitive member C had a universal hardness HU of 1.4×10⁸ N/m² and an elastic deformation ratio Wo of 48%.

### Example 1

The Toner 1 and the Developer 1 were evaluated as follows.

A remodeled machine was prepared using a color copying machine CLC-1000 manufactured by CANON KABUSHIKI KAISHA. An oil-applying device was detached so as to freely set the fixing temperature. Furthermore, the Electrophotographic photosensitive member A was installed as the photosensitive member. A copying test of 40,000-successive copies was performed in a normal temperature environment (N/N environment 23° C./60%) using an original having an image area ratio of 25%.

The low-temperature fixing property was evaluated as follows: A preset temperature of a fixing device was varied from 120° C. at 5° C. intervals, and fixed images were printed out at each temperature. The fixed images were rubbed using Silbon paper with a load of 4.9 kPa (50 g/cm²) to compare the depth of the images with that of the image before rubbing. A temperature at which the decreasing ratio of the depth was 10% or less was defined as a fixation starting temperature.

The transfer performance was evaluated as follows: Images before and after the 40,000-copy durability test were developed and transferred. The toner content on the photosensitive member before transfer (per unit area) and the toner content on the transferred material (per unit area) were measured to calculate the transfer efficiency represented by the following formula:

$$Transfer efficiency ( \% ) = ( Toner content on the transferred material ) / ( Toner content on the photosensitive member before tranfer ) \times 100$$

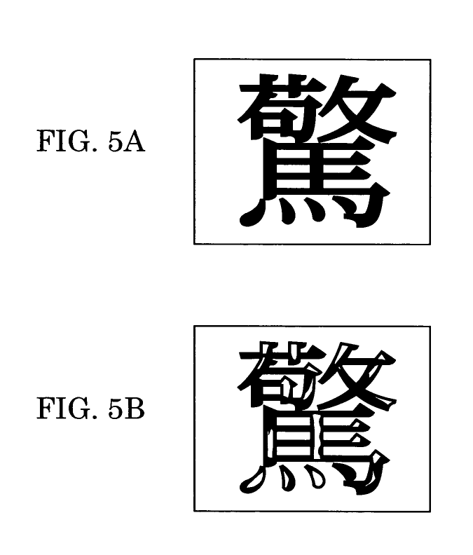

The transfer void was evaluated as follows: A character pattern shown in FIG. 5A was printed on cardboard (128 g/m²). The void of the character (the state shown in FIG. 5B) was evaluated as follows by visual inspection.
A: Void was barely generated.
B: Minor voids were generated.
C: Some voids were generated.
D: Significant voids were generated.

Fogging was evaluated as follows: The whiteness in the white background of white paper and that in the non-image areas of transferred paper were measured with a reflect meter manufactured by Tokyo Denshoku Co., Ltd. Fogging density (%) was calculated by the difference between the whiteness in the white background of white paper and that in the non-image areas of the transferred paper. The evaluation criteria were as follows:
A: Excellent (less than 0.5%)
B: Good (0.5% to less than 1.5%)
C: Normal (1.5% to less than 2.5%)
D: Inferior (2.5% to less than 3.5%)
E: Not good (3.5% or more)

Filming was evaluated as follows: After the 40,000-copy durability test, the thickness of the surface layer of the Electrophotographic photosensitive member A was measured with a reflection spectral interferometer MCDP2000 manufactured by Otsuka Electronics Co., Ltd. Subsequently, the surface of the electrophotographic photosensitive member was delicately rubbed 10 times with a wet soft cloth to which an alumina powder having a diameter of 100 μm was adhered. The degree of force required for this rubbing was confirmed in advance: This rubbing was performed with a force that would not scrape off the surface layer when an unused Electrophotographic photosensitive member A was rubbed.

Thereafter, the thickness of the surface layer was measured again with the reflection spectral interferometer. The difference between the thickness before rubbing and the thickness after rubbing was defined as the amount of filming. The results were evaluated by the following criteria.
A: Excellent. No filming was generated.
B: Good. The amount of filming was 50 Å or less.
C: No problem in practical use. The amount of filming was 100 Å or less.
D: Not good. Since the amount of filming exceeded 100 Å, cleaning defects might be generated.

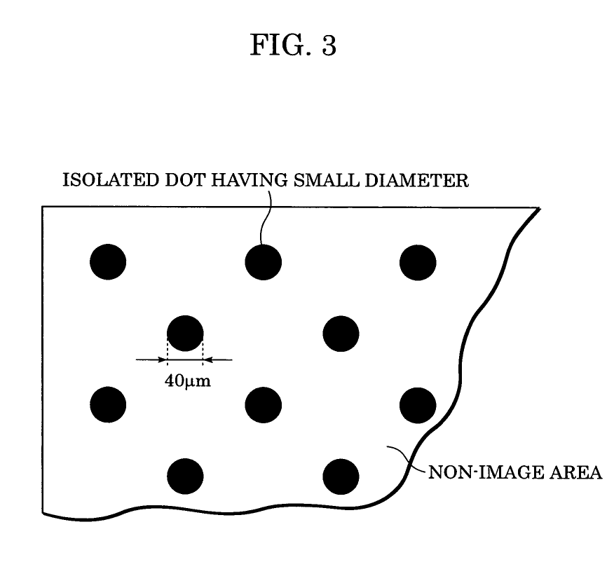

A dot reproducibility was evaluated as follows: An isolated dot pattern image having a small diameter (40 μm) shown in FIG. 3 was printed out. Since the electric field is readily closed by the latent image electric field, it is difficult to reproduce this pattern. The dot reproducibility was evaluated using 100 dots in the pattern.
A: Excellent. The number of defects was 2 or less per 100 dots.
B: Good. The number of defects was 3 to 5 per 100 dots.
C: Normal. The number of defects was 6 to 10 per 100 dots.
D: Not good. The number of defects exceeded 11 per 100 dots.

Tables 4 and 5 show the results. According to the results of the evaluation, even after 40,000 images were formed, Toner 1 showed excellent transfer performance and did not cause fogging. In addition, Toner 1 showed excellent dot reproducibility and did not generate filming.

### Example 2

Toner 2 and Developer 2 were evaluated as in Example 1. Although the transfer efficiency in Example 2 was somewhat lower than that in Example 1, this decrease did not cause any problems. Other characteristics were excellent. Tables 4 and 5 show the results.

### Example 3

Toner 3 and Developer 3 were evaluated as in Example 1. After the 40,000-copy durability test, the filming resistance in Example 3 was somewhat deteriorated, compared with that in Example 1. However, this deterioration did not cause any problems. Other characteristics were excellent. Tables 4 and 5 show the results.

### Example 4

Toner 4 and Developer 4 were evaluated as in Example 1. The dot reproducibility in Example 4 was somewhat deteriorated, compared with that in Example 1. However, this deterioration did not cause any problems. Other characteristics were excellent. Tables 4 and 5 show the results.

### Example 5

Toner 5 and Developer 5 were evaluated as in Example 1. After the 40,000-copy durability test, fogging was somewhat generated in Example 5, compared with that in Example 1. However, this fogging did not cause any problems. Also, the initial transfer efficiency was somewhat decreased, and the filming resistance was somewhat deteriorated. However, these deteriorations did not cause any problems. Other characteristics were excellent. Tables 4 and 5 show the results.

### Example 6

Toner 6 and Developer 6 were evaluated as in Example 1. The dot reproducibility and the low-temperature fixing property in Example 6 were somewhat deteriorated, compared with those in Example 1. However, these deteriorations did not cause any problems in practical use. Other characteristics were excellent. Tables 4 and 5 show the results.

### Example 7

Toner 7 and Developer 7 were evaluated as in Example 1. After the 40,000-copy durability test, fogging and filming were somewhat generated in Example 7, compared with those in Example 1. Also, the transfer performance was somewhat deteriorated. However, these deteriorations were acceptable in practical use. Other characteristics did not cause any problems. Tables 4 and 5 show the results.

### Example 8

Toner 8 and Developer 8 were evaluated as in Example 1. The transfer performance, the dot reproducibility, and the low-temperature fixing property in Example 8 were somewhat deteriorated, compared with those in Example 1. However, these deteriorations were acceptable in practical use. Other characteristics did not cause any problems. Tables 4 and 5 show the results.

### Example 9

Toner 9 and Developer 9 were evaluated as in Example 1. After the 40,000-copy durability test, fogging, filming, and transfer void were somewhat generated in Example 9, compared with those in Example 1. Also, the transfer performance was somewhat deteriorated. However, these deteriorations were acceptable in practical use. Other characteristics did not cause any problems. Tables 4 and 5 show the results.

### Example 10

Magenta toner 1 and Magenta developer 1 were produced as in the Toner-producing method 1, except that C.I. Pigment Blue 15:3 was replaced with C.I. Pigment Red 57:1 (6 parts by weight). Yellow toner 1 and Yellow developer 1 were produced as in the Toner-producing method 1, except that C.I. Pigment Blue 15:3 was replaced with C.I. Pigment Yellow 74 (7 parts by weight). In addition, Black toner 1 and Black developer 1 were produced as in the Toner-producing method 1, except that C.I. Pigment Blue 15:3 was replaced with carbon black (3 parts by weight).

The above magenta, yellow, and black toners and the above magenta, yellow, and black developers were evaluated as in Example 1 using the above CLC-1000 remodeled machine with a full color mode. The low-temperature fixing property and the dot reproducibility of the toners and the developers were as excellent as those in Example 1. The initial transfer efficiency was 93%. After the 40,000-copy durability test, the transfer efficiency was as good as 90%. Filming and fogging were not generated.

Furthermore, a 10,000-copy durability test was performed using the Electrophotographic photosensitive member B, Cyan toner 1, Magenta toner 1, Yellow toner 1, and Black toner 1 with a remodeled machine of a commercially available full color copy machine (Creative Processor 660 manufactured by CANON KABUSHIKI KAISHA), which employs a nonmagnetic one-component development system. The durability test was performed in a normal temperature environment (N/N environment 23° C./60%) with a full color mode using an original. According to the evaluation results, there were no problems in the low-temperature fixing property, fogging, the transfer performance, and the dot reproducibility. Filming was also not generated.

### Comparative Example 1

Toner 10 and Developer 10 were evaluated as in Example 1. The transfer efficiency and the low-temperature fixing property in Comparative example 1 were deteriorated, compared with those in Example 1. In addition, after the 40,000-copy durability test, the filming resistance was also deteriorated. Tables 4 and 5 show the results.

### Comparative Example 2

Toner 11 and Developer 11 were evaluated as in Example 1. After the 40,000-copy durability test, fogging, the filming resistance, and transfer void in Comparative example 2 were particularly deteriorated, compared with those in Example 1. The transfer efficiency was also decreased. Tables 4 and 5 show the results.

### Comparative Example 3

Toner 12 and Developer 12 were evaluated as in Example 1. The low-temperature fixing property and the dot reproducibility in Comparative example 3 were particularly deteriorated, compared with those in Example 1. After the 40,000-copy durability test, the transfer efficiency and the fogging were also deteriorated. Tables 4 and 5 show the results.

### Comparative Example 4

Toner 13 and Developer 13 were evaluated as in Example 1. After the 40,000-copy durability test, fogging and the transfer void in Comparative example 4 were significantly deteriorated, compared with those in Example 1. Also, the transfer efficiency was decreased, and the filming resistance was deteriorated. Tables 4 and 5 show the results.

### Comparative Example 5

Toner 14 and Developer 14 were evaluated as in Example 1. After the 40,000-copy durability test, fogging and the transfer void in Comparative example 5 were significantly deteriorated, compared with those in Example 1. The transfer efficiency was significantly decreased. The dot reproducibility and the filming resistance were also deteriorated. Tables 4 and 5 show the results.

### Comparative Example 6

Toner 15 and Developer 15 were evaluated as in Example 1. The low-temperature fixing property, the dot reproducibility, and transfer performance in Comparative example 6 were significantly deteriorated, compared with those in Example 1. After the 40,000-copy durability test, fogging was also deteriorated. Tables 4 and 5 show the results.

### Comparative Example 7

Toner 16 and Developer 16 were evaluated as in Example 1. The transfer performance, the dot reproducibility, and the transfer void in Comparative example 7 were significantly deteriorated, compared with those in Example 1. Also, the fixation starting temperature was not found in Comparative example 7. After the 40,000-copy durability test, fogging and the filming resistance were significantly deteriorated. Tables 4 and 5 show the results.

### Comparative Example 8

Toner 8 and Developer 8 were evaluated as in Example 1, except that the Electrophotographic photosensitive member A was replaced with the Electrophotographic photosensitive member C. In Comparative example 8, after the 40,000-copy durability test, the Electrophotographic photosensitive member C used in the test was detached from the color copy machine. Flaws were found on the surface of the photosensitive member. The filming resistance in Comparative example 8 was deteriorated, compared with that in Example 8. Tables 4 and 5 show the results.

TABLE 1

| | | | | Measurement results of | | |
|---|---|---|---|---|---|---|
| | | | | molecular weight (GPC) | | |
| | Monomer | | Tg | Mw | Mn | |
| | (parts by weight) | | (° C.) | (×10³) | (×10³) | Mw/Mn |
| Polyester 1 | PO-BPA | (30) | 64 | 110 | 4.1 | 26.8 |
| | EO-BPA | (10) | | | | |
| | Fumaric acid | (27) | | | | |
| | Terephthalic | (20) | | | | |
| | acid | | | | | |
| | Trimellitic | (3) | | | | |
| | anhydride | | | | | |
| Polyester 2 | PO-BPA | (50) | 55 | 53 | 2.5 | 21.2 |
| | Fumaric acid | (25) | | | | |
| | Terephthalic | (25) | | | | |
| | acid | | | | | |
| Polyester 3 | PO-BPA | (25) | 73 | 310 | 4.1 | 75.6 |
| | EO-BPA | (15) | | | | |
| | Fumaric acid | (25) | | | | |
| | Terephthalic | (17) | | | | |
| | acid | | | | | |
| | Trimellitic | (8) | | | | |
| | anhydride | | | | | |
| Hybrid | Styrene | (10) | 61 | 88 | 3.9 | 22.6 |
| resin | 2-Ethylhexyl | (5) | | | | |
| | acrylate | | | | | |
| | α-methyl- | (5) | | | | |
| | styrene | | | | | |
| | PO-BPA | (25) | | | | |
| | EO-BPA | (15) | | | | |
| | Fumaric acid | (26) | | | | |
| | Succinic acid | (11) | | | | |
| | Trimellitic | (3) | | | | |
| | anhydride | | | | | |

TABLE 2

| | Maximum endothermic peak | Type |
|---|---|---|
| Wax A | 67° C. | Refined n-paraffin |
| Wax B | 110° C. | Polyethylene |

TABLE 3

| | | | | | Charge control |
|---|---|---|---|---|---|
| | | | Colorant | Wax | agent |
| | Resin | | (parts by | (parts by | (parts by |
| | (parts by weight) | | weight) | weight) | weight) |
| Toner 1 | Polyester 1 | (100) | C.I. | Wax A (6.0) | Aluminum 3,5- |
| | | | Pigment | | di-tert-butyl |
| | | | Blue 15:3 | | salicylate |
| | | | (4) | | (2.0) |
| Toner 2 | Polyester 1 | (100) | ↑ | Wax A (6.0) | ↑ (2.0) |
| Toner 3 | Polyester 1 | (100) | ↑ | Wax A (6.0) | ↑ (2.0) |
| Toner 4 | Polyester 1 | (100) | ↑ | Wax A (6.0) | ↑ (2.0) |
| Toner 5 | Polyester 1 | (100) | ↑ | Wax A (6.0) | ↑ (2.0) |
| Toner 6 | Polyester 1 | (70) | ↑ | Wax A (6.0) | ↑ (1.0) |
| | Polyester 3 | (30) | | | |
| Toner 7 | Hybrid resin | (100) | ↑ | Wax A (6.0) | ↑ (2.0) |
| Toner 8 | Polyester 1 | (50) | ↑ | Wax A (6.0) | ↑ (1.0) |
| | Polyester 3 | (50) | | | |
| Toner 9 | Polyester 1 | (50) | ↑ | Wax A (6.0) | ↑ (1.0) |
| | Polyester 2 | (50) | | | |
| Toner | Polyester 3 | (100) | ↑ | Wax A (6.0) | ↑ (0.5) |
| 10 | | | | | |
| Toner | Polyester 2 | (100) | ↑ | Wax A (6.0) | ↑ (2.0) |
| 11 | | | | | |
| Toner | Polyester 3 | (100) | ↑ | Wax A (6.0) | ↑ (3.0) |
| 12 | | | | | |
| Toner | Polyester 2 | (100) | ↑ | Wax B (6.0) | None |
| 13 | | | | | |
| Toner | Polyester 2 | (100) | ↑ | Wax B (6.0) | None |
| 14 | | | | | |
| Toner | Polyester 3 | (100) | ↑ | Wax B (6.0) | Aluminum 3,5- |
| 15 | | | | | di-tert-butyl |
| | | | | | salicylate |
| | | | | | (3.0) |
| Toner | Polyester 2 | (100) | ↑ | Wax A (1.0) | None |
| 16 | | | | | |

TABLE 4

| | | Temperature | Weight average | |
|---|---|---|---|---|
| | Viscoelasticity | (° C.) | particle | |
| | of toner G′80 | at which | diameter D4 | Average |
| | (Pa) | tanδ = 1 | (μm) | circularity |
| Example 1 | 1.02 × 10⁶ | 65.0 | 6.0 | 0.930 |
| Example 2 | 1.03 × 10⁶ | 65.0 | 6.1 | 0.924 |
| Example 3 | 1.02 × 10⁶ | 65.0 | 6.9 | 0.946 |
| Example 4 | 1.02 × 10⁶ | 65.0 | 7.5 | 0.942 |
| Example 5 | 1.03 × 10⁶ | 65.0 | 5.1 | 0.929 |
| Example 6 | 8.53 × 10⁶ | 67.0 | 7.4 | 0.945 |
| Example 7 | 9.60 × 10⁵ | 63.0 | 5.0 | 0.947 |
| Example 8 | 1.02 × 10⁷ | 70.0 | 7.7 | 0.919 |
| Example 9 | 5.10 × 10⁵ | 61.0 | 4.8 | 0.947 |
| Comparative | 9.51 × 10⁷ | 74.0 | 7.8 | 0.920 |
| example 1 | | | | |
| Comparative | 1.42 × 10⁵ | 56.0 | 4.4 | 0.948 |
| example 2 | | | | |
| Comparative | 1.03 × 10⁸ | 74.0 | 7.9 | 0.917 |
| example 3 | | | | |
| Comparative | 9.50 × 10⁴ | 56.0 | 4.1 | 0.949 |
| example 4 | | | | |
| Comparative | 9.50 × 10⁴ | 56.0 | 4.2 | 0.952 |
| example 5 | | | | |
| Comparative | 1.03 × 10⁸ | 74.0 | 8.0 | 0.912 |
| example 6 | | | | |
| Comparative | 9.90 × 10⁴ | 56.0 | 3.9 | 0.910 |
| example 7 | | | | |
| Comparative | 1.02 × 10⁷ | 70.0 | 7.7 | 0.919 |
| example 8 | | | | |

TABLE 5

| | | | | Transfer | | | | | |
|---|---|---|---|---|---|---|---|---|---|
| | | | | efficiency | | | | | |
| | | | | (%) | | | | Filming resistance | |
| | Fixation | | | Initial → | | Dot reproducibility | | Difference | |
| | starting | Fogging | | After | | Number | | between layer | |
| | temperature | Density | | durability | Transfer | of | | thicknesses | |
| | (° C.) | (%) | Evaluation | test | void | defects | Evaluation | (Å) | Evaluation |
| Example 1 | 130 | 0.3 | A | 93 → 91 | A | 0 | A | 0 | A |
| Example 2 | 130 | 0.3 | A | 91 → 90 | A | 0 | A | 0 | A |
| Example 3 | 130 | 0.4 | A | 95 → 92 | A | 1 | A | 6 | B |
| Example 4 | 130 | 0.4 | A | 92 → 91 | A | 3 | B | 0 | A |
| Example 5 | 130 | 0.6 | B | 91 → 89 | B | 2 | A | 15 | B |
| Example 6 | 140 | 0.4 | A | 95 → 93 | A | 4 | B | 0 | A |
| Example 7 | 125 | 0.7 | B | 95 → 90 | B | 2 | A | 35 | B |
| Example 8 | 145 | 0.8 | B | 94 → 91 | A | 5 | B | 0 | A |
| Example 9 | 125 | 0.9 | B | 94 → 88 | C | 2 | A | 40 | B |
| Comparative | 160 | 1.6 | C | 89 → 85 | A | 7 | C | 67 | C |
| example 1 | | | | | | | | | |
| Comparative | 120 | 2.7 | D | 91 → 84 | C | 8 | C | 105 | D |
| example 2 | | | | | | | | | |
| Comparative | 170 | 2.7 | D | 88 → 84 | B | 12 | D | 76 | C |
| example 3 | | | | | | | | | |
| Comparative | 140 | 3.6 | E | 92 → 83 | D | 10 | C | 109 | D |
| example 4 | | | | | | | | | |
| Comparative | 140 | 3.8 | E | 94 → 81 | D | 13 | D | 115 | D |
| example 5 | | | | | | | | | |
| Comparative | 180 | 3.0 | D | 86 → 83 | B | 14 | D | 93 | C |
| example 6 | | | | | | | | | |
| Comparative | Not found | 4.2 | E | 83 → 78 | D | 16 | D | 120 | D |
| example 7 | | | | | | | | | |
| Comparative | 145 | 1.2 | B | 92 → 89 | B | 5 | B | 45 | B |
| example 8 | | | | | | | | | |

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. An image forming apparatus in which an electrostatic latent image formed on an electrophotographic photosensitive member is developed with a toner, the image forming apparatus comprising:
the electrophotographic photosensitive member comprising at least a conductive support, a photosensitive layer disposed on the support, and a surface layer composed of a curing resin, wherein the electrophotographic photosensitive member has a universal hardness (HU) of 1.5×10⁸ to 2.3×10⁸ N/m², the universal hardness being measured in an environment of 25° C. with a humidity of 50% using a Vickers diamond indenter having a quadrangular pyramid shape with a maximum indentation load of 6 mN, and the electrophotographic photosensitive member has an elastic deformation ratio of 46% to 65%; and
the toner comprising at least a binder resin, a colorant, and a release agent, wherein (i) the toner has a weight average particle diameter (D4) of 4.0 to 8.0 μm, (ii) the average circularity of the toner having an equivalent circle diameter of at least 2 μm is 0.915 to 0.950, and (iii) the toner has a storage modulus (G′80) at 80° C. of 1×10⁵ to 1×10⁸ Pa, and a ratio of a loss modulus G″ of the toner to the storage modulus G′ of the toner (G″/G′=tan δ) is equal to 1 at a temperature in the range of 60° C. to 72° C.

2. The image forming apparatus according to claim 1, wherein the surface of the electrophotographic photoreceptor comprises a curing resin produced by polymerizing to cure a compound having at least one polymerizable group represented by chemical formula (1): 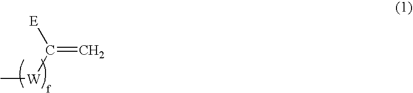
wherein E represents a hydrogen atom, a halogen atom, an alkyl group that may have a substituent, an aryl group that may have a substituent, a cyano group, a nitro group, an alkoxy group, —COOR¹ (wherein R¹ represents a hydrogen atom, a halogen atom, an alkyl group that may have a substituent, an aralkyl group that may have a substituent, or an aryl group that may have a substituent), or —CONR²R³ (wherein R² and R³ independently represents a hydrogen atom, a halogen atom, an alkyl group that may have a substituent, an aralkyl group that may have a substituent, or an aryl group that may have a substituent, and R² and R³ may be identical or different); W represents a divalent arylene group that may have a substituent, a divalent alkylene group that may have a substituent, —COO—, —C—, —O—, —OO—, —S—, or —CONR⁴— (wherein R⁴ represents a hydrogen atom, a halogen atom, an alkyl group that may have a substituent, an aralkyl group that may have a substituent, or an aryl group that may have a substituent); and f represents 0 or 1.

3. The image forming apparatus according to claim 2, wherein the compound having the polymerizable group represented by chemical formula (1) is a chain-polymerizable compound having at least two polymerizable groups present in its molecule represented by chemical formula (1).

4. The image forming apparatus according to claim 2, wherein the polymerizable group is represented by any one of chemical formulae (2) to (6):

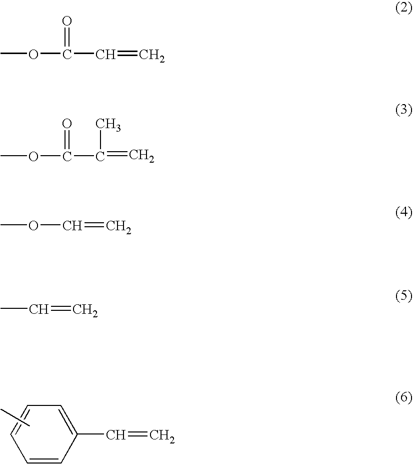

5. A method for forming an image by developing an electrostatic latent image formed on an electrophotographic photosensitive member with a toner, the method comprising:
using the electrophotographic photosensitive member comprising at least a conductive support, a photosensitive layer formed on the support, and a surface layer composed of a curing resin, wherein the electrophotographic photosensitive member has a universal hardness (HU) of 1.5×10⁸ to 2.3×10⁸ N/m², the universal hardness being measured in an environment of 25° C. with a humidity of 50% using a Vickers diamond indenter having a quadrangular pyramid shape with a maximum indentation load of 6 mN, and the electrophotographic photosensitive member has an elastic deformation ratio of 46% to 65%, and
the toner comprising at least a binder resin, a colorant, and a release agent, wherein (i) the toner has a weight average particle diameter (D4) of 4.0 to 8.0 μm, (ii) the average circularity of the toner having an equivalent circle diameter of at least 2 μm is 0.915 to 0.950, and (iii) the toner has a storage modulus (G′80) at 80° C. of 1×10⁵ to 1×10⁸ Pa, and a ratio of a loss modulus G′ of the toner to the storage modulus G′ of the toner (G″/G′=tan δ) is equal to 1 at a temperature in the range of 60° C. to 72° C.
